(19) United States
(12) Patent Application Publication
(10) Pub. No.: US 2015/0004975 A1
(43) Pub. Date: Jan. 1, 2015

(54) WIRELESS BASE STATION DEVICE, COMMUNICATION CONTROL METHOD AND COMMUNICATION CONTROL PROGRAM

(71) Applicants: Hirotsugu Yamamoto, Osaka-shi (JP); Takashi Yamamoto, Osaka-shi (JP)

(72) Inventors: Hirotsugu Yamamoto, Osaka-shi (JP); Takashi Yamamoto, Osaka-shi (JP)

(73) Assignee: SUMITOMO ELECTRIC INDUSTRIES, LTD., Osaka-shi, Osaka (JP)

(21) Appl. No.: 14/241,272

(22) PCT Filed: Aug. 28, 2012
(86) PCT No.: PCT/JP2012/071706

§ 371 Date: Feb. 26, 2014

(30) Foreign Application Priority Data
Sep. 7, 2011 (JP) 2011-194664

(51) Int. Cl. H04W 36/24

(52) U.S. Cl. CPC H04W 36/24
USPC 455/436

(57) ABSTRACT

A wireless base station device transmits and receives a radio signal to and from a wireless terminal device in a communication system in which the wireless terminal device is communicable with a plurality of wireless base station devices by performing a moving operation. The wireless base station device includes: a terminal power information acquisition section that acquires terminal power information indicating a degree of change in a reception power of the radio signal in a wireless terminal device existing in the range of a cell formed by the wireless base station device, with respect to a positional change of the wireless terminal device; and a moving operation control section that controls, based on the terminal power information acquired by the terminal power information acquisition section, timing of the moving operation of the wireless terminal device from the wireless base station device to another wireless base station device.

### TECHNICAL FIELD

The present invention relates to a wireless base station device, a communication control method, and a communication control program. More particularly, the present invention relates to a wireless base station device, a communication control method, and a communication control program in a communication system in which a wireless terminal device is communicable with a plurality of wireless base station devices by performing a moving operation.

### BACKGROUND ART

In conventional mobile communication systems, communication services have been provided by wireless base station devices (hereinafter also referred to as macro base stations) each forming a cell having a radius ranging from several hundreds of meters to several tens of kilometers, i.e., an area in which wireless terminal devices are allowed to communicate with the wireless base station device.

In recent years, with a dramatic increase in the number of subscribers of mobile communication services and an increase in communication traffic due to data communication, it is desired to distribute the subscribers and the communication traffic over cells having smaller radii, and to reliably provide users with a certain level of communication speed. Further, as a countermeasure against blind zones caused by skyscrapers, it is desired to install wireless base station devices in office floors and ordinary houses.

In association with these requirements, downsizing of wireless base station devices has progressed by remarkable improvement in throughput of various devices used in the wireless base station devices, and downsized base stations have attracted attention.

Such downsized base stations (hereinafter also referred to as femto base stations) form femto cells, and each femto cell has a radius as small as about 10 meters. Therefore, it is conceivable that the femto base stations are used in places outside the ranges of macro cells formed by macro base stations, or places where it is difficult to install macro base stations, such as indoors, underground malls, and the like.

Since many femto base stations are installed in a specific area, it is difficult to directly connect the femto base stations to a core network. Therefore, it is conceivable that the many femto base stations installed in the specific area are connected to a gateway device such as an HeNB-GW, and the femto base stations are connected to the core network via the HeNB-GW.

Further, in addition to the femto base stations, pico base stations, each forming a pico cell having, for example, a radius ranging from 100 meters to 200 meters, have been developed based on macro base stations.

In a heterogeneous network serving as a communication system in which such femto base stations, pico base stations, and macro base stations coexist, a plurality of femto cells or pico cells are formed in each macro cell, for example. Therefore, handovers of wireless terminal devices are more likely to occur, and the situations where such handovers occur are complicated, which may cause an inappropriate handover operation such as too early handover or too late handover (refer to, for example, 3GPP TR 36.902 V9.3.1 2011.3 (Non-Patent Literature 1)).

### CITATION LIST

### Non Patent Literature

Non-Patent Literature 1: 3GPP TR 36.902 V9.3.1 2011.3

### SUMMARY OF INVENTION

### Technical Problem

An inappropriate handover operation as described in Non-Patent Literature 1 may cause various problems in the communication system, such as disconnection of communication, increase in communication traffic, and the like. A technique for suppressing such an inappropriate handover operation to establish a favorable communication system has been desired.

The present invention is made to solve the above-mentioned problems, and an object of the present invention is to provide a wireless base station device, a communication control method, and a communication control program which are capable of stabilizing communication by appropriately controlling moving operations of wireless terminal devices.

### Solution to Problem

(1) A wireless base station device according to an aspect of the present invention is a wireless base station device that transmits and receives a radio signal to and from a wireless terminal device in a communication system in which the wireless terminal device is communicable with a plurality of wireless base station devices by performing a moving operation. The wireless base station device includes: a terminal power information acquisition section that acquires terminal power information indicating a degree of change in a reception power of the radio signal in a wireless terminal device existing in the range of a cell formed by the wireless base station device, with respect to a positional change of the wireless terminal device; and a moving operation control section that controls, based on the terminal power information acquired by the terminal power information acquisition section, timing of the moving operation of the wireless terminal device from the wireless base station device to another wireless base station device.

According to the above configuration, the timing of the moving operation can be appropriately controlled by using the change of the reception state in association with the positional change of the wireless terminal device, thereby suppressing an inappropriate moving operation, and establishing a favorable communication system. Accordingly, stabilized communication can be achieved by appropriately controlling the moving operation of the wireless terminal device.

(2) Preferably, the moving operation control section controls the timing of the moving operation to be advanced when the degree of change indicated by the terminal power information is large, and controls the timing of the moving operation to be delayed when the degree of change is small.

According to the above configuration, the moving operation can be optimized by appropriately setting the parameter for controlling the timing of the moving operation.

(3) Preferably, the moving operation control section sets a control width for the timing of the moving operation to be large when the degree of change indicated by the terminal power information is large, and sets the control width for the timing of the moving operation to be small when the degree of change is small.

Thus, the convergence speed and stability of the process of optimizing the moving operation can be enhanced by adaptively changing the step size of parameter adjustment.

(4) Preferably, the terminal power information acquisition section acquires the terminal power information indicating the degree of change in a state where an index indicating a reception quality of the radio signal transmitted from the wireless base station device is equal to or smaller than a predetermined value in the wireless terminal device, or in a state where a reception power of a radio signal transmitted from the another wireless base station device is equal to or larger than a predetermined value in the wireless base station device.

According to the above configuration, the timing of the moving operation can be controlled more appropriately by using the degree of change at an appropriate position in the wireless communication system.

(5) Preferably, the wireless base station device further includes a terminal power estimation section that estimates the degree of change, based on a distance between the wireless base station device and the another wireless base station device. The terminal power information acquisition section acquires, as the terminal power information, the degree of change estimated by the terminal power estimation section.

According to the above configuration, the reception environment of the wireless terminal device can be appropriately evaluated in accordance with the magnitude of the inter-base-station distance, thereby estimating the degree of change more accurately.

(6) More preferably, the wireless base station device further includes an inter-base-station distance estimation section that estimates the distance between the wireless base station device and the another wireless base station device, based on a difference between a transmission power of the radio signal transmitted from the another wireless base station device and a reception power, in the cell formed by the wireless base station device, of the radio signal transmitted from the another wireless base station device. The terminal power estimation section estimates the degree of change based on the distance estimated by the inter-base-station distance estimation section.

According to the above configuration using a downlink path loss which is the difference between the transmission power of the radio signal in the another wireless base station device and the reception power of the radio signal in the own cell, the inter-base-station distance can be estimated more accurately. Further, a user need not previously set the inter-base-station distance in the wireless base station device.

(7) Preferably, the wireless base station device further includes a terminal power estimation section that estimates the degree of change, based on a difference between a transmission power of the radio signal transmitted from the wireless base station device and a transmission power of a radio signal transmitted from the another wireless base station device. The terminal power information acquisition section acquires, as the terminal power information, the degree of change estimated by the terminal power estimation section.

According to the above configuration, the reception environment of the wireless terminal device can be appropriately evaluated in accordance with the magnitude of the difference in transmission power between the base stations, thereby estimating the degree of change more accurately.

(8) Preferably, the wireless base station device further includes a terminal power estimation section that estimates the degree of change, based on a moving velocity of the wireless terminal device existing in the range of the cell formed by the wireless base station device. The terminal power information acquisition section acquires, as the terminal power information, the degree of change estimated by the terminal power estimation section.

According to the above configuration, the reception environment of the wireless terminal device can be appropriately evaluated in accordance with the magnitude of the moving velocity of the wireless terminal device, thereby estimating the degree of change more accurately.

(9) Preferably, the wireless base station device further includes a terminal power estimation section that estimates the degree of change, based on a temporal change in a difference between a transmission power of a radio signal transmitted from the another wireless base station device, and a reception power, in the cell formed by the wireless base station device, of the radio signal transmitted from the another wireless base station device. The terminal power information acquisition section acquires, as the terminal power information, the degree of change estimated by the terminal power estimation section.

According to the above configuration, the reception environment of the wireless terminal device can be appropriately evaluated in accordance with the magnitude of the temporal change in a downlink path loss which is the difference between the transmission power of the radio signal of the another wireless base station device and the reception power of the radio signal in the own cell, thereby estimating the degree of change more accurately.

(10) Preferably, the wireless base station device further includes a terminal power estimation section that estimates the degree of change, based on a temporal change in a difference between a transmission power of a radio signal transmitted from the wireless terminal device existing in the range of the cell formed by the wireless base station device, and a reception power of the radio signal in the wireless base station device. The terminal power information acquisition section acquires, as the terminal power information, the degree of change estimated by the terminal power estimation section.

According to the above configuration, the reception environment of the wireless terminal device can be appropriately evaluated in accordance with the magnitude of the temporal change in an uplink path loss which is the difference between the transmission power of the radio signal of the wireless terminal device and the reception power of the radio signal in the wireless base station device, thereby estimating the degree of change more accurately.

(11) Preferably, the wireless base station device further includes a terminal power estimation section that estimates the degree of change, based on a difference between a frequency of a radio signal transmitted from the wireless terminal device existing in the range of the cell formed by the wireless base station device, and a frequency of the radio signal received by the wireless base station device. The terminal power information acquisition section acquires, as the terminal power information, the degree of change estimated by the terminal power estimation section.

According to the above configuration, the reception environment of the wireless terminal device can be appropriately evaluated in accordance with the magnitude of a Doppler shift which is the difference between the frequency of the radio signal of the wireless terminal device and the frequency of the radio signal received by the wireless base station device, thereby estimating the degree of change more accurately.

(12) Preferably, the wireless base station device further includes a terminal power estimation section that estimates the degree of change, based on a temporal change in a reception power of a radio signal in the wireless terminal device. The terminal power information acquisition section acquires, as the terminal power information, the degree of change estimated by the terminal power estimation section.

According to the above configuration, the reception environment of the wireless terminal device can be appropriately evaluated in accordance with the magnitude of shadowing which is the temporal change in the reception power of the radio signal in the wireless terminal device, thereby estimating the degree of change more accurately.

(13) More preferably, the terminal power estimation section acquires the temporal change in the reception power, based on a measurement result of a reception power of a radio signal in a wireless terminal device existing in the range of the cell formed by the wireless base station device.

According to the configuration using the measurement result of the wireless terminal device, the shadowing in the wireless terminal device can be estimated more accurately.

(14) More preferably, the terminal power estimation section estimates the degree of change, based on the temporal change in the reception power of the wireless terminal device having a high moving velocity among a plurality of wireless terminal devices existing in the range of the cell formed by the wireless base station device.

According to the configuration in which the wireless terminal device whose shadowing is more likely to increase is selected and the reception environment of the selected wireless tell final device is estimated, the degree of change can be estimated more accurately.

(15) A wireless base station device according to another aspect of the present invention is a wireless base station device that transmits and receives a radio signal to and from a wireless terminal device in a communication system in which the wireless terminal device is communicable with a plurality of wireless base station devices by performing a moving operation. The wireless base station device includes an information acquisition section and a moving operation control section. The information acquisition section acquires at least one piece of information among: a distance between the wireless base station device and another wireless base station device; a difference in transmission power between a radio signal transmitted from the wireless base station device and a radio signal transmitted from the another wireless base station device; a moving velocity of a wireless terminal device existing in the range of a cell formed by the wireless base station device; a temporal change in a difference between the transmission power of the radio signal transmitted from the another wireless base station device and a reception power, in the cell formed by the wireless base station device, of the radio signal transmitted from the another wireless base station device; a temporal change in a difference between a transmission power of a radio signal transmitted from the wireless terminal device existing in the range of the cell formed by the wireless base station device, and a reception power of the radio signal in the wireless base station device; a difference between a frequency of the radio signal transmitted from the wireless terminal device existing in the cell formed by the wireless base station device, and a frequency of the radio signal received by the wireless base station device; and a temporal change in a reception power of a radio signal in a wireless terminal device. The moving operation control section controls timing of a moving operation of a wireless terminal device from the wireless base station device to the another wireless base station device, based on the information acquired by the information acquisition section.

According to the above configuration, the reception environment of the wireless terminal device can be appropriately evaluated, and thereby the timing of the moving operation can be appropriately controlled. Therefore, it is possible to suppress an inappropriate moving operation, and configure a favorable communication system. Accordingly, stabilized communication can be achieved by appropriately controlling the moving operation of the wireless terminal device.

(16) A wireless terminal device according to an aspect of the present invention is a communication control method for a wireless base station device that transmits and receives a radio signal to and from a wireless terminal device in a communication system in which the wireless terminal device is communicable with a plurality of wireless base station devices by performing a moving operation. The communication control method includes the steps of: acquiring terminal power information indicating a degree of change in a reception power of the radio signal in a wireless terminal device existing in the range of a cell formed by the wireless base station device, with respect to a positional change of the wireless terminal device; and controlling, based on the acquired terminal power information, timing of the moving operation of the wireless terminal device from the wireless base station device to another wireless base station device.

According to the above configuration, the timing of the moving operation can be appropriately controlled by using the change of the reception state in association with the positional change of the wireless terminal device, thereby suppressing an inappropriate moving operation, and establishing a favorable communication system. Accordingly, stabilized communication can be achieved by appropriately controlling the moving operation of the wireless terminal device.

(17) A communication control program according to an aspect of the present invention is a communication control program for a wireless base station device that transmits and receives a radio signal to and from a wireless terminal device in a communication system in which the wireless terminal device is communicable with a plurality of wireless base station devices by performing a moving operation. The communication control program causes a computer to execute the steps of: acquiring terminal power information indicating a degree of change in a reception power of the radio signal in a wireless terminal device existing in the range of a cell formed by the wireless base station device, with respect to a positional change of the wireless terminal device; and controlling, based on the acquired terminal power information, timing of the moving operation of the wireless terminal device from the wireless base station device to another wireless base station device.

According to the above configuration, the timing of the moving operation can be appropriately controlled by using the change of the reception state in association with the positional change of the wireless terminal device, thereby suppressing an inappropriate moving operation, and establishing a favorable communication system. Accordingly, stabilized communication can be achieved by appropriately controlling moving operations of wireless terminal devices.

### Advantageous Effects of Invention

According to the present invention, stabilized communication can be achieved by appropriately controlling a moving operation of a wireless terminal device.

### BRIEF DESCRIPTION OF DRAWINGS

FIG. 1 is a diagram showing a configuration of a wireless communication system according to an embodiment of the present invention.

FIG. 2 is a diagram showing an example of a sequence of a handover operation in the wireless communication system according to the embodiment of the present invention.

FIG. 3 is a diagram showing an example of a situation where an inappropriate handover operation (Too Late HO) occurs in the wireless communication system according to the embodiment of the present invention.

FIG. 4 is a diagram showing an inappropriate handover operation (Too Late HO) and an example of a sequence of a process for detecting the same, in the wireless communication system according to the embodiment of the present invention.

FIG. 5 is a diagram showing an example of a situation where an inappropriate handover operation (Too Early HO) occurs in the wireless communication system according to the embodiment of the present invention.

FIG. 6 is a diagram showing an example of a situation where an inappropriate handover operation (Too Early HO) occurs in the wireless communication system according to the embodiment of the present invention.

FIG. 7 is a diagram showing an inappropriate handover operation (Too Early HO) and an example of a sequence of a process for detecting the same, in the wireless communication system according to the embodiment of the present invention.

FIG. 8 is a diagram showing an example of a situation where an inappropriate handover operation (HO to Wrong Cell) occurs in the wireless communication system according to the embodiment of the present invention.

FIG. 9 is a diagram showing an inappropriate handover operation (HO to Wrong Cell) and an example of a sequence of a process for detecting the same, in the wireless communication system according to the embodiment of the present invention.

FIG. 10 is a diagram showing a simulation result of a reception quality of a wireless terminal device in the wireless communication system according to the embodiment of the present invention.

FIG. 11 is a diagram showing an event A1 in which a wireless terminal device transmits a measurement result notification in the wireless communication system according to the embodiment of the present invention.

FIG. 12 is a diagram showing an event A2 in which a wireless terminal device transmits a measurement result notification in the wireless communication system according to the embodiment of the present invention.

FIG. 13 is a diagram showing an event A3 in which a wireless terminal device transmits a measurement result notification in the wireless communication system according to the embodiment of the present invention.

FIG. 14 is a diagram showing an event A4 in which a wireless terminal device transmits a measurement result notification in the wireless communication system according to the embodiment of the present invention.

FIG. 15 is a diagram showing an event A5 in which a wireless terminal device transmits a measurement result notification in the wireless communication system according to the embodiment of the present invention.

FIG. 16 is a diagram showing handover operation timing control by adjusting hysteresis HS in the wireless communication system according to the embodiment of the present invention.

FIG. 17 is a diagram showing handover operation timing control by adjusting TTT in the wireless communication system according to the embodiment of the present invention.

FIG. 18 is a diagram showing handover operation timing control by adjusting offset OST in the wireless communication system according to the embodiment of the present invention.

FIG. 19 is a diagram showing an example of reception powers of a radio signal at different positions in the wireless communication system according to the embodiment of the present invention.

FIG. 20 is a diagram for explaining another example of a parameter for controlling handover operation timing in the wireless communication system according to the embodiment of the present invention.

FIG. 21 is a diagram showing a configuration of a wireless base station device according to the embodiment of the present invention.

FIG. 22 is a diagram showing a configuration of a control unit in the wireless base station device according to the embodiment of the present invention.

FIG. 23 is a diagram for explaining a difference in power change amount due to an inter-base-station distance.

FIG. 24 is a sequence diagram defining an operation procedure along which the wireless base station device according to the embodiment of the present invention performs a handover operation optimizing process.

FIG. 25 is a diagram for explaining a difference in power change amount due to a difference in transmission power between base stations.

FIG. 26 is a sequence diagram defining another example of an operation procedure along which the wireless base station device according to the embodiment of the present invention performs a handover operation optimizing process.

FIG. 27 is a sequence diagram defining another example of an operation procedure along which the wireless base station device according to the embodiment of the present invention performs a handover operation optimizing process.

FIG. 28 is a sequence diagram defining another example of an operation procedure along which the wireless base station device according to the embodiment of the present invention performs a handover operation optimizing process.

FIG. 29 is a sequence diagram defining another example of an operation procedure along which the wireless base station device according to the embodiment of the present invention performs a handover operation optimizing process.

FIG. 30 is a sequence diagram defining another example of an operation procedure along which the wireless base station device according to the embodiment of the present invention performs a handover operation optimizing process.

FIG. 31 is a sequence diagram defining another example of an operation procedure along which the wireless base station device according to the embodiment of the present invention performs a handover operation optimizing process.

### DESCRIPTION OF EMBODIMENTS

Hereinafter, an embodiment of the present invention will be described with reference to the drawings. In the drawings, the same or corresponding parts are denoted by the same reference numerals, and will not be repeatedly described.

A wireless base station device notifies a wireless terminal device of information about a cell formed by itself and neighboring cells, i.e., the frequency of a radio signal, IDs (identifications) of the neighboring cells, and the like. Based on the information notified from the wireless base station device, the wireless terminal device detects and measures a neighboring cell. Based on the result of the measurement, the wireless terminal device starts to move to the neighboring cell. Here, that a wireless terminal device “moves” means that a wireless terminal device “performs handover”, and also means that a wireless terminal device “selects” a cell through which the wireless terminal device in the idle mode will start communication, i.e., phone call or data communication, in the future.

For example, when a wireless terminal device is communicating with a wireless base station device, the wireless base station device or a host device in a core network determines the destination of the wireless terminal device. Further, for example, when a wireless terminal device is not communicating with a wireless base station device, the wireless terminal device determines the destination of the wireless terminal device.

Further, “handover” means switching of a wireless base station device to be a communication partner of a wireless terminal device during phone call or data communication.

Further, a state where a wireless terminal device exists in the range of a cell means a state where the wireless terminal device selects, as a communication destination, a wireless base station device that forms the cell, and is communicable with or is communicating with the wireless base station device.

In 3GPP (Third Generation Partnership Project) SPEC TS22.220, a femto cell and access modes thereof are described as follows. That is, a femto base station is customer premises equipment that connects a wireless terminal device connected thereto via a wireless interface, to a mobile carrier network by using an IP backhaul.

Regarding the access modes of the femto cell, a femto base station in a closed access mode provides services to only associated CSG (Closed Subscriber Group) members. A femto base station in a hybrid mode provides services to associated CSG members and to non-CSG members. A femto base station in an open access mode operates as a normal base station.

Such definitions based on 3GPP may be applied to the wireless communication system according to the embodiment of the present invention.

Further, the following definitions may be applied in combination with or separately from the above definitions.

A macro base station and a pico base station are wireless base station devices under the management of a mobile carrier, and wireless base station devices that subscribe to the mobile carrier are allowed to communicate with the macro base station and the pico base station. Further, it is considered that the macro base station and the pico base station are basically not powered off.

On the other hand, a femto base station is a wireless base station device that is mainly installed in a personal or corporate building, and is likely to be moved or powered off depending on user's circumstances.

Further, the femto base station operates in any of the open, hybrid, and closed access modes. When the femto base station operates in the closed access mode, only registered members (terminals) are allowed to access the femto base station. When the femto base station operates in the closed access mode, the femto base station provides services to only the registered members. When the femto base station operates in the hybrid mode, the femto base station provides services to both the registered members and unregistered members, i.e., non-members. When the femto base station operates in the open access mode, the femto base station operates in the same manner as the macro base station and the pico base station.

[Configuration and Basic Operation]

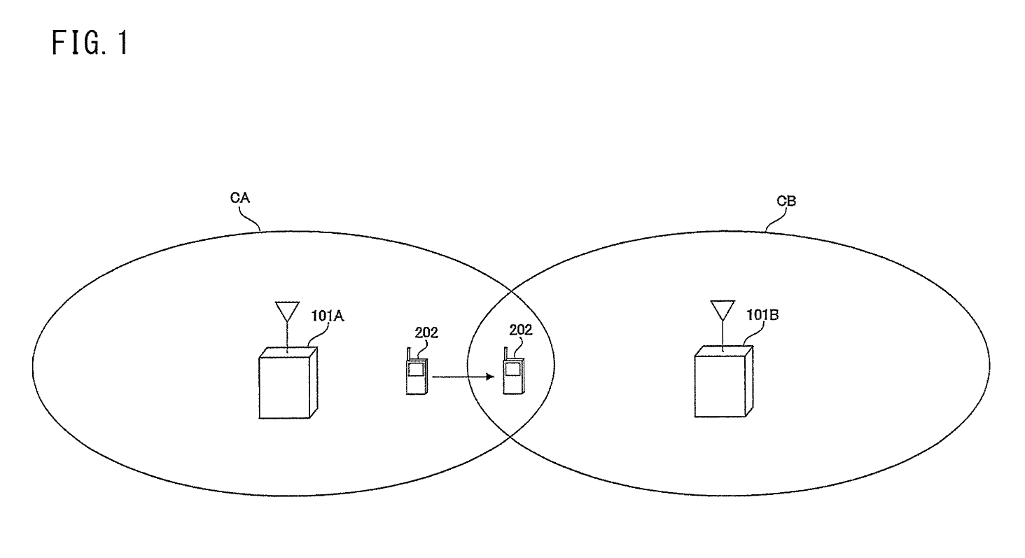

FIG. 1 is a diagram showing the configuration of a wireless communication system according to the embodiment of the present invention.

With reference to FIG. 1, the wireless communication system is a mobile communication system that complies with, for example, LTE (Long Term Evolution) standardized in 3GPP (Third Generation Partnership Project), and includes wireless base station devices 101A and 101B. Although the two wireless base station devices are representatively shown in FIG. 1, more wireless base station devices may be provided.

The wireless base station devices 101A and 101B are, for example, any of a femto base station, a pico base station, and a macro base station.

The wireless base station device 101A forms a cell CA, and is communicable with a wireless terminal device 202 existing in the cell CA by transmitting/receiving a radio signal to/from the wireless terminal device 202. The wireless base station device 101B forms a cell CB, and is communicable with the wireless terminal device 202 existing in the cell CB by transmitting/receiving a radio signal to/from the wireless terminal device 202.

Hereinafter, a direction from a wireless terminal device to a core network is referred to as an uplink direction, and a direction from the core network to the wireless terminal device is referred to as a downlink direction.

The wireless base station devices and the wireless terminal device in the wireless communication system according to the embodiment of the present invention each read, from a memory (not shown) a program including steps in sequences described below, and execute the program. This program can be externally installed. The program to be installed is stored in, for example, a recording medium for distribution.

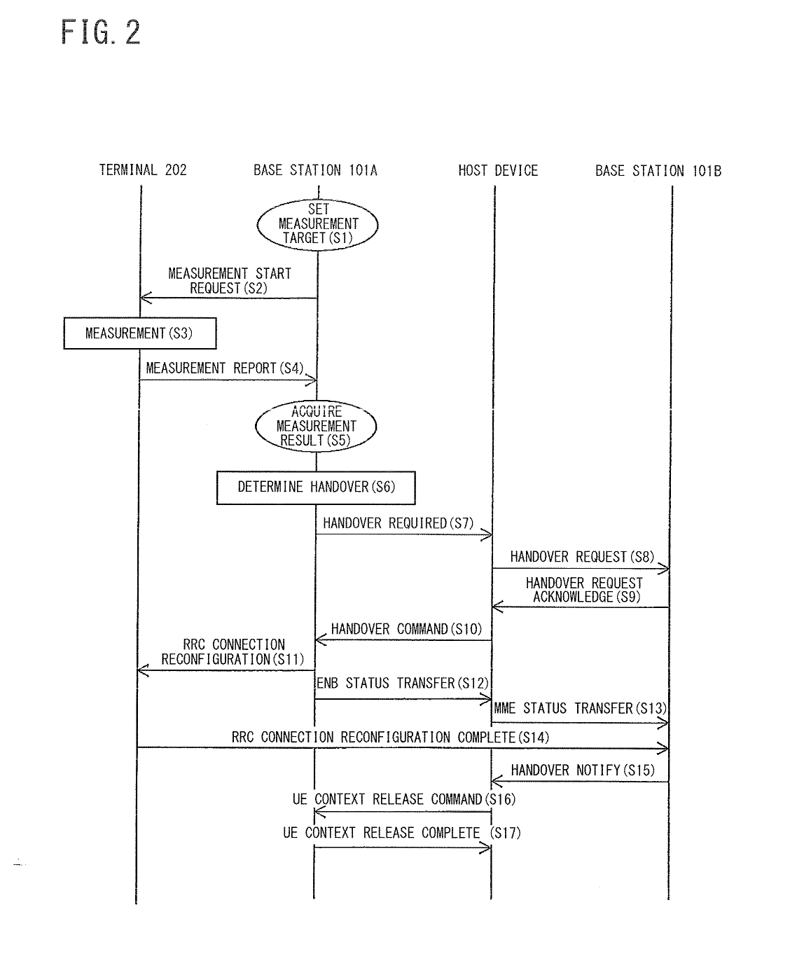

FIG. 2 is a diagram showing an example of a sequence of a handover operation in the wireless communication system according to the embodiment of the present invention.

A case is assumed in which the wireless terminal device 202, existing in the cell CA and communicating with the wireless base station device 101A, moves to an overlap region of the cell CA and the cell CB, as shown in FIG. 1.

With reference to FIG. 2, first, the wireless base station device 101A sets a frequency to be measured by the wireless terminal device 202 communicating with the wireless base station device 101A, and other wireless base station devices each transmitting a radio signal of the frequency (step S1).

Next, the wireless base station device 101A transmits, to the wireless terminal device 202, a measurement start request (Measurement Configuration) that causes the wireless terminal device 202 to measure the reception levels of the radio signals transmitted from the other wireless base station devices that have been set. The measurement start request includes neighboring cell information, i.e., the cell IDs of the wireless base station devices as the measurement targets. Further, the measurement start request includes the transmission frequencies of the respective wireless base station devices (step S2).

Upon receiving the measurement start request from the wireless base station device 101A, the wireless terminal device 202 starts a power measurement process (Measurement), i.e., measures the reception powers of the radio signals transmitted from the wireless base station devices indicated by the measurement start request, at the frequency indicated by the received measurement start request (step S3).

Next, the wireless terminal device 202 transmits a measurement result notification (Measurement Report) indicating the measurement results of the reception powers to the wireless base station device 101A. For example, the wireless terminal device 202 periodically performs the reception power measurement, and when the communication state with the wireless base station device 101A is deteriorated or when the communication state with a wireless base station device other than the wireless base station device 101A is improved, the wireless terminal device 202 transmits the measurement result notification to the wireless base station device 101A (step S4).

Based on the measurement result notification received from the wireless terminal device 202, the wireless base station device 101A acquires measurement information indicating the measurement result of each cell ID, and stores the measurement information in a storage section that is not shown (step S5).

Based on the measurement result notification received from the wireless terminal device 202, the wireless base station device 101A determines whether or not handover of the wireless terminal device 202 should be performed. Upon determining that handover of the wireless terminal device 202 should be performed, the wireless base station device 101A determines, for example, the wireless base station device 101B as a handover destination, with reference to the neighboring cell information (step S6).

Next, the wireless base station device 101A transmits a handover request (Handover Required) indicating the wireless base station device 101B to the host device (step S7).

Upon receiving the handover request from the wireless base station device 101A, the host device transmits the handover request to the wireless base station device 101B (step S8).

Upon receiving the handover request from the host device, the wireless base station device 101B transmits, to the host device, a handover response (Handover Request Acknowledge) to the handover request (step S9).

Next, upon receiving the handover response from the wireless base station device 101B, the host device transmits a handover instruction (Handover Command) to the wireless base station device 101A (step S10).

Upon receiving the handover instruction from the host device, the wireless base station device 101A transmits an RRC (Radio Resource Control) connection reconfiguration instruction (RRC Connection Reconfiguration) to the wireless terminal device 202 (step S11).

Next, the wireless base station device 101A transmits, to the host device, a state notification (eNB Status Transfer) indicating its own communication state and the like (step S12).

Upon receiving the state notification from the wireless base station device 101A, the host device transmits, to the wireless base station device 101B, a state notification (MME Status Transfer) indicating the content of communication with the wireless terminal device 202, and the like (step S13).

When an RRC connection has been established between the wireless terminal device 202 and the wireless base station device 101B, the wireless terminal device 202 transmits an RRC connection reconfiguration completion notification (RRC Connection Reconfiguration Complete) to the wireless base station device 101B (step S14).

Upon receiving the RRC connection reconfiguration completion notification from the wireless terminal device 202, the wireless base station device 101B transmits a handover completion notification (Handover Notify) to the host device (step S15).

Upon receiving the handover completion notification from the wireless base station device 101B, the host device transmits a UE context release instruction (UE Context Release Command) to the wireless base station device 101A (step S16).

Upon receiving the UE context release instruction from the host device, the wireless base station device 101A releases the information relating to the wireless terminal device 202, and transmits a UE context release completion notification (UE Context Release Complete) to the host device (step S17).

[Examples of Inappropriate Handover Operation]

Hereinafter, a wireless base station device communicating with the wireless terminal device 202 or a wireless base station device as a handover source is also referred to as a serving base station, and a wireless base station device as a handover destination is also referred to as a neighboring base station.

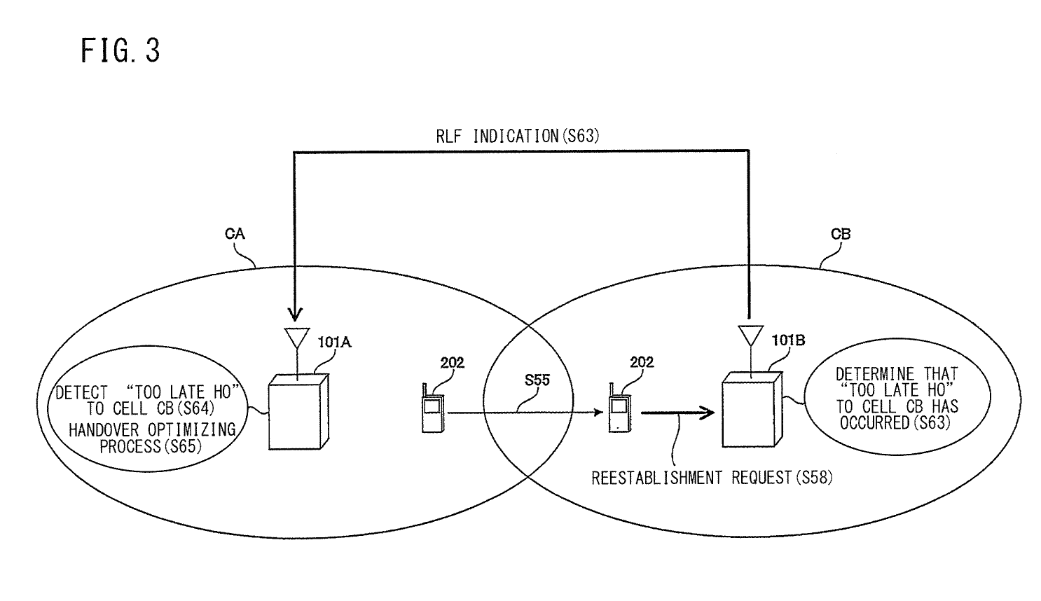

FIG. 3 shows an example of a situation where an inappropriate handover operation (Too Late HO) occurs in the wireless communication system according to the embodiment of the present invention.

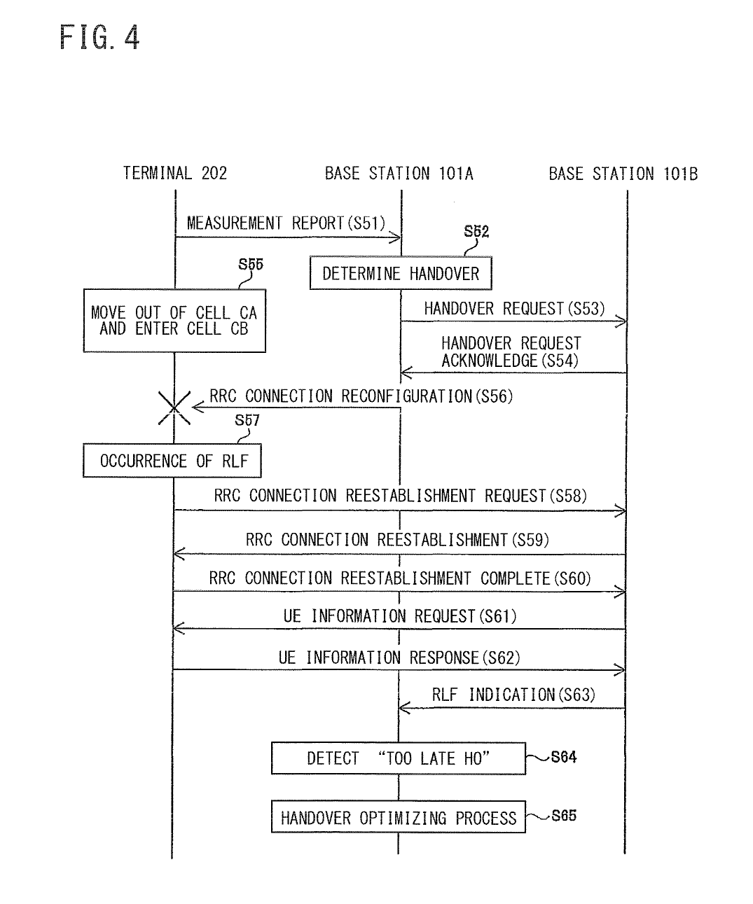

FIG. 4 is a diagram showing an inappropriate handover operation (Too Late HO) and an example of a sequence of a process for detecting the same, in the wireless communication system according to the embodiment of the present invention.

An example of “Too Late HO” is as follows. That is, before handover starts or during a handover process, a radio link failure (RLF) occurs with respect to a wireless base station device as a handover source, and reestablishment of connection of the wireless terminal device 202 to a wireless base station device other than the handover source wireless base station device occurs.

An example of a “Too Late HO” detection method is as follows. That is, when the wireless terminal device 202 has caused an RLF with respect to the wireless base station device 101A and thereafter reestablished a radio link to the wireless base station device 101B, the wireless base station device 101B transmits an RLF notification to the wireless base station device 101A. Thereby, the wireless base station device 101A detects “Too Late HO”.

It is now assumed that, as shown in FIG. 3, the wireless terminal device 202 is located in the cell CA and is communicating with the wireless base station device 101A.

With reference to FIGS. 3 and 4, first, the wireless terminal device 202 measures the reception powers of the radio signals transmitted from the respective wireless base station devices, and transmits a measurement result notification indicating the measurement results of the reception powers to the wireless base station device 101A (step S51).

Based on the measurement result notification received from the wireless terminal device 202, the wireless base station device 101A determines whether or not handover of the wireless terminal device 202 should be performed. Upon determining that handover of the wireless terminal device 202 should be performed, the wireless base station device 101A determines, for example, the wireless base station device 101B as a handover destination with reference to the neighboring cell information (step S52).

Then, the wireless base station device 101A transmits a handover request indicating the wireless base station device 101B to the wireless base station device 101B via an X2 interface as an inter-base-station interface (step S53).

Upon receiving the handover request from the wireless base station device 101A, the wireless base station device 101B transmits a handover response (Handover Request Acknowledge) to the handover request, to the wireless base station device 101A via the X2 interface (step S54).

During the preparation for handover on the network side, that is, while the wireless base station devices 101A and 101B exchange the messages for handover as described above, the wireless terminal device 202 moves out of the range of the cell CA and enters the range of the cell CB (step S55).

Due to this movement of the wireless terminal device 202, an RRC connection reconfiguration instruction that instructs handover (step S56), which is transmitted from the wireless base station device 101A, does not arrive at the wireless terminal device 202, and thus an RLF occurs (step S57).

Upon detecting the occurrence of the RLF, the wireless terminal device 202 searches the neighboring wireless base station devices by, for example, measuring the reception powers of the radio signals, and transmits an RRC connection reestablishment request in order to achieve reconnection to the found wireless base station device 101B (step S58).

Upon receiving the RRC connection reestablishment request from the wireless terminal device 202, the wireless base station device 101B transmits an RRC connection reestablishment response (RRC Connection Reestablishment) to the wireless terminal device 202 (step S59). Thereby, an RRC connection is established between the wireless terminal device 202 and the wireless base station device 101B.

Next, the wireless terminal device 202 transmits an RRC connection reestablishment completion notification (RRC Connection Reestablishment Complete) to the wireless base station device 101B (step S60).

The RRC connection reestablishment completion notification includes a parameter “rlf-InfoAvailable”, for example. The wireless terminal device 202 specifies this parameter in the RRC connection reestablishment completion notification, and transmits the notification. Thereby, the wireless base station device 101B recognizes that an RLF has occurred with respect to the wireless terminal device 202. In order to acquire detailed information about the RLF, the wireless base station device 101B transmits a UE context request (UE Information Request) to the wireless terminal device 202 (step S61).

Upon receiving the UE context request from the wireless base station device 101B, the wireless terminal device 202 transmits a UE context response (UE Information Response) including an RLF report to the wireless base station device 101B (step S62). The RLF report includes: PCI (Physical Cell ID) of the wireless base station device in which the RLF has occurred; PCI and ECGI (E-UTRAN Cell Global Identifier) of the wireless base station device in which the RRC connection reestablishment has occurred; C-RNTI (Cell Radio Network Temporary Identifier) of the wireless terminal device 202; and the like. The PCI for which the RLF has occurred corresponds to the ID of the wireless base station device 101A, the PCI and ECGI for which the RRC connection reestablishment has occurred correspond to the ID of the wireless base station device 101B, and the C-RNTI corresponds to the ID assigned by the wireless base station device 101A.

Next, with reference to the PCIs in the RLF report received from the wireless terminal device 202, the wireless base station device 101B recognizes that an RLF has occurred in the wireless base station device 101A. Then, in order to notify the “Too Late HO”, the wireless base station device 101B transmits an RLF notification (RLF INDICATION) including the content of the RLF report to the wireless base station device 101A via the X2 interface (step S63).

Next, with reference to the PCIs, ECGI, and C-RNTI in the RLF notification received from the wireless base station device 101B, the wireless base station device 101A recognizes that “Too Late HO” to the cell CB has occurred (step S64).

Next, the wireless base station device 101A performs a handover operation optimizing process so as to suppress occurrence of “Too Late HO” to the cell CB (step S65).

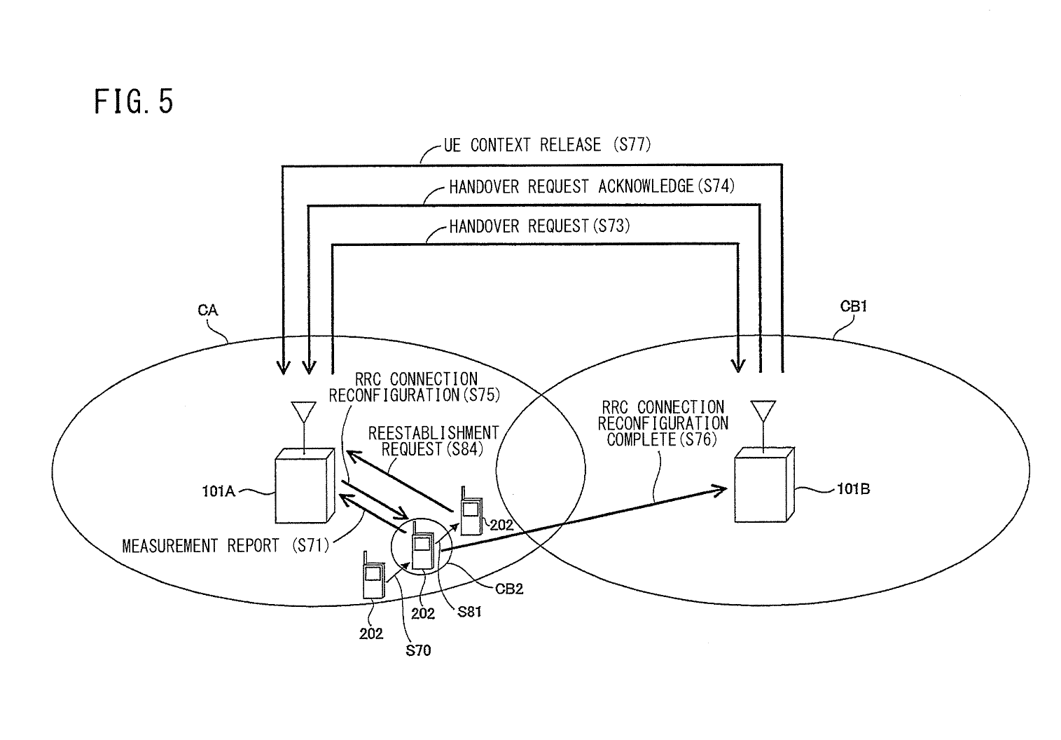

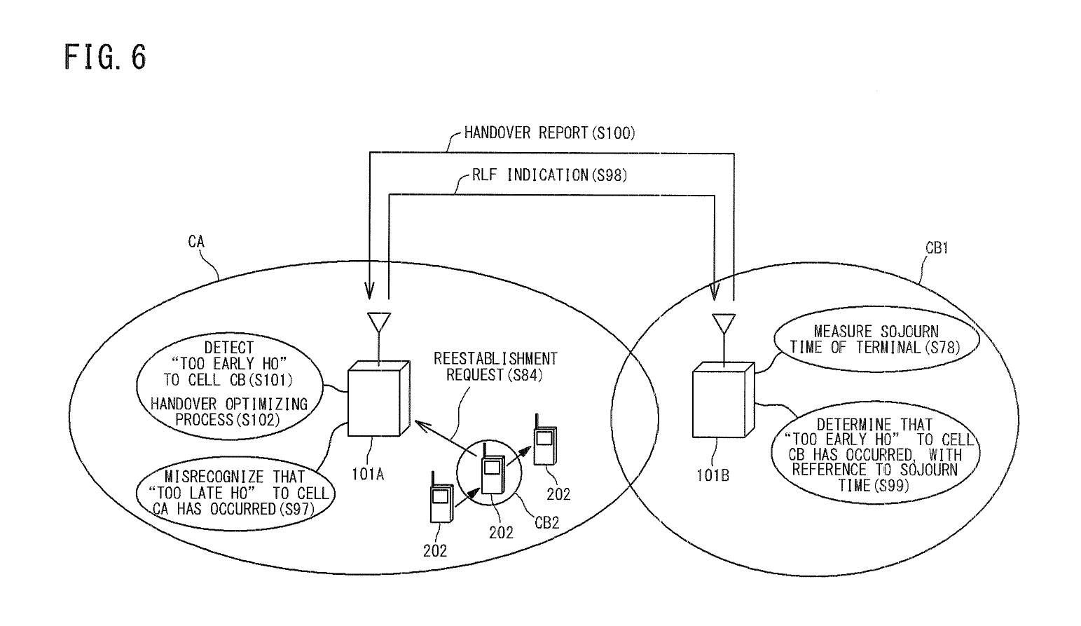

FIGS. 5 and 6 are diagrams showing an example of a situation where an inappropriate handover operation (Too Early HO) occurs in the wireless communication system according to the embodiment of the present invention.

With reference to FIGS. 5 and 6, the cell CB formed by the wireless base station device 101B consists of a cell CB1 that includes an area where the wireless base station device 101B is installed, and a cell CB2 that is formed in the cell CA and does not include the area where the wireless base station device 101B is installed.

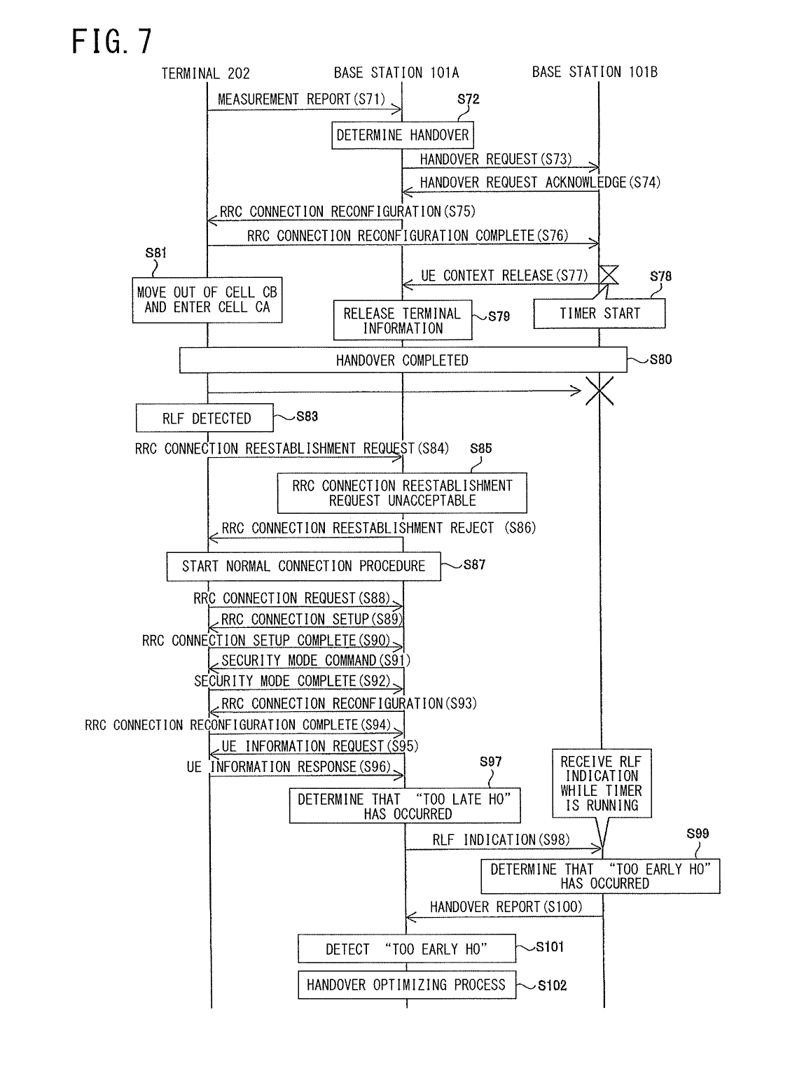

FIG. 7 is a diagram showing an inappropriate handover operation (Too Early HO) and an example of a sequence of a process for detecting the same, in the wireless communication system according to the embodiment of the present invention.

An example of “Too Early HO” is as follows. That is, after the wireless terminal device 202 has succeeded in connecting itself to the wireless base station device as the handover destination, an RLF occurs in a short time, and reestablishment of connection of the wireless terminal device 202 to the wireless base station device as the handover source occurs.

An example of a “Too Early HO” detection method is as follows. That is, in the case where the wireless base station device 101B as the handover destination receives the RLF report from the wireless base station device 101A as the handover source, if the wireless base station device 101B has transmitted, to the wireless base station device 101A, a UE context release instruction due to completion of handover of the wireless terminal device 202 to the wireless base station device 101B, within a predetermined time period prior to the reception timing, the wireless base station device 101B notifies the wireless base station device 101A that “Too Early HO” has occurred.

The wireless base station device 101B uses a timer to measure the predetermined time period. Thereby, the wireless base station device 101B, when receiving the RLF report, can determine whether the RLF has occurred due to its “Too Late HO” or due to “Too Early HO” of the wireless base station device 101A.

It is now assumed that, as shown in FIG. 5, the wireless terminal device 202, being located in the cell CA and communicating with the wireless base station device 101A, moves to the cell CB2 (step S70).

With reference to FIGS. 5 to 7, first, the wireless terminal device 202 measures the reception powers of the radio signals transmitted from the wireless base station devices, and transmits a measurement result notification indicating the measurement results of the reception powers to the wireless base station device 101A (Source eNB, Serving eNB) (step S71).

Next, based on the measurement result notification received from the wireless terminal device 202, the wireless base station device 101A determines whether or not handover of the wireless terminal device 202 should be performed. Upon determining that handover of the wireless terminal device 202 should be performed, the wireless base station device 101A determines, for example, the wireless base station device 101B as a handover destination with reference to the neighboring cell information (step S72).

Next, the wireless base station device 101A transmits a handover request indicating the wireless base station device 101B to the wireless base station device 101B via an X2 interface as an inter-base-station interface (step S73).

Upon receiving the handover request from the wireless base station device 101A, the wireless base station device 101B transmits a handover response to the handover request, to the wireless base station device 101A via the X2 interface (step S74).

Upon receiving the handover response from the wireless base station device 101B, the wireless base station device 101A transmits an RRC connection reconfiguration instruction (RRC Connection Reconfiguration) to the wireless terminal device 202 (step S75).

When an RRC connection has been established between the wireless terminal device 202 and the wireless base station device 101B, the wireless terminal device 202 transmits an RRC connection reconfiguration completion notification (RRC Connection Reconfiguration Complete) to the wireless base station device 101B (step S76).

Upon receiving the RRC connection reconfiguration completion notification from the wireless terminal device 202, the wireless base station device 101B transmits a UE context release instruction (UE Context Release) to the wireless base station device 101A (step S77).

Further, the wireless base station device 101B starts the timer to measure the cell dwell time of the wireless terminal device 202 in the cell CB (step S78).

Upon receiving the UE context release instruction from the wireless base station device 101B, the wireless base station device 101A releases the information (UE Context) relating to the wireless terminal device 202 (step S79).

Thus, the handover of the wireless terminal device 202 from the wireless base station device 101A to the wireless base station device 101B is completed (step S80).

Before the wireless terminal device 202 transmits the measurement result notification (Measurement Report) to the wireless base station device 101B, the wireless terminal device 202 moves out of the range of the cell CB and enters the range of the cell CA (step S81).

Then, the wireless terminal device 202 becomes incapable of communicating with the wireless base station device 101B, and therefore, an RLF occurs (step S83).

When detecting the occurrence of RLF, the wireless terminal device 202 searches the neighboring wireless base station devices by, for example, measuring the reception powers of the radio signals, and transmits an RRC connection reestablishment request in order to achieve reconnection to the found wireless base station device 101A (step S84).

Since the wireless base station device 101A has already released and therefore does not have the information (UE Context) relating to the wireless terminal device 202, the wireless base station device 101A cannot accept the RRC connection reestablishment request from the wireless terminal device 202 (step S85). Therefore, the wireless base station device 101A transmits an RRC connection reestablishment reject to the wireless terminal device 202 (step S86).

Upon receiving the RRC connection reestablishment rejection from the wireless base station device 101A, the wireless terminal device 202 starts a usual connection procedure with the wireless base station device 101A (step S87).

That is, first, the wireless terminal device 202 transmits an RRC connection request to the wireless base station device 101A (step S88).

Upon receiving the RRC connection request from the wireless terminal device 202, the wireless base station device 101A transmits RRC connection information (RRC Connection Setup) to the wireless terminal device 202 (step S89).

Upon receiving the RRC connection information from the wireless base station device 101A, the wireless terminal device 202 transmits an RRC connection completion notification (RRC Connection Setup Complete) (step S90).

Upon receiving the RRC connection completion notification from the wireless terminal device 202, the wireless base station device 101A transmits security information (Security Mode Command) to the wireless terminal device 202 (step S91).

Upon receiving the security information from the wireless base station device 101A, the wireless terminal device 202 transmits a security completion notification (Security Mode Complete) to the wireless base station device 101A (step S92).

Next, the wireless base station device 101A transmits an RRC connection reconfiguration instruction (RRC Connection Reconfiguration) to the wireless terminal device 202 (step S93).

When an RRC connection has been established between the wireless terminal device 202 and the wireless base station device 101A, the wireless terminal device 202 transmits an RRC connection reconfiguration completion notification (RRC Connection Reconfiguration Complete) to the wireless base station device 101A (step S94).

The RRC connection completion notification and the RRC connection reconfiguration completion notification each include a parameter “rlf-InfoAvailable”, for example. The wireless terminal device 202 specifies this parameter in each of the RRC connection completion notification and the RRC connection reconfiguration completion notification, and transmits the notification. Thereby, the wireless base station device 101A recognizes that an RLF has occurred with respect to the wireless terminal device 202. The wireless base station device 101A transmits a UE context request (UE Information Request) to the wireless terminal device 202 in order to acquire detailed information about the RLF (step S95).

Upon receiving the UE context request from the wireless base station device 101A, the wireless terminal device 202 transmits a UE context response (UE Information Response) including an RLF report to the wireless base station device 101A (step S96). The RLF report includes: the PCI of the wireless base station device in which the RLF has occurred; the PCI and ECGI of the wireless base station device in which the RRC connection reestablishment has occurred; and the C-RNTI of the wireless terminal device 202. The PCI for which the RLF has occurred corresponds to the ID of the wireless base station device 101B, the PCI and ECGI for which the RRC connection reestablishment has occurred corresponds to the ID of the wireless base station device 101A, and the C-RNTI corresponds to the ID assigned by the wireless base station device 101B.

Next, with reference to the PCIs in the RLF report received from the wireless terminal device 202, the wireless base station device 101A recognizes that the RLF has occurred in the wireless base station device 101B, and determines that “Too Late HO” to the cell CA has occurred (step S97).

Next, in order to notify the “Too Late HO”, the wireless base station device 101A transmits an RLF notification (RLF INDICATION) including the content of the RLF report to the wireless base station device 101B via the X2 interface (step S98).

Upon receiving the RLF notification from the wireless base station device 101A, the wireless base station device 101B checks the timer that has been started. If the timer is running, i.e., if the predetermined time period has not elapsed from when the timer was started, the wireless base station device 101B determines that not “Too Late HO” to the cell CA but “Too Early HO” to the cell CB has occurred. If the timer is not running when the wireless base station device 101B has received the RLF notification from the wireless base station device 101A, i.e., if the predetermined time period has elapsed from when the timer was started, the wireless base station device 101B determines that “Too Late HO” to the cell CA has occurred.

Upon determining that “Too Early HO” to the cell CB has occurred (step S99), the wireless base station device 101B transmits a handover report to the wireless base station device 101A (step S100). This handover report includes a parameter “Handover Report Type”, for example. The wireless base station device 101B sets this parameter to a specific value to notify the wireless base station device 101A of the “Too Early HO”.

Upon receiving the handover report from the wireless base station device 101B, the wireless base station device 101A recognizes that “Too Early HO” to the cell CB has occurred (step S101), and performs a handover operation optimizing process to suppress the occurrence of “Too Early HO” (step S102).

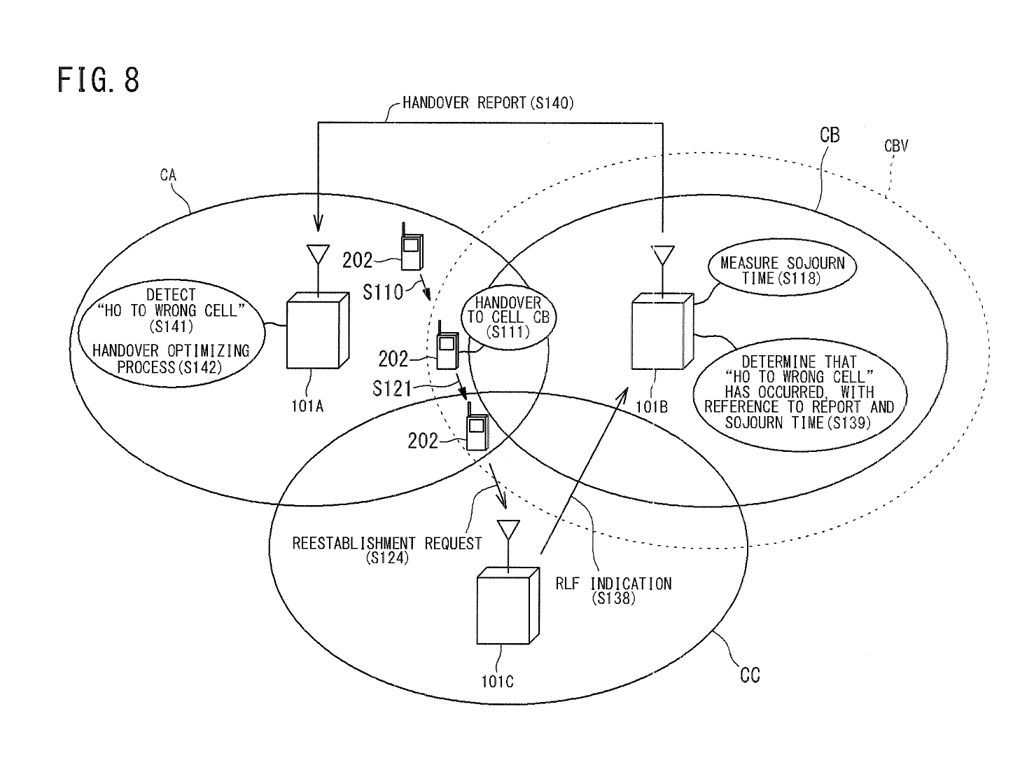

FIG. 8 is a diagram showing an example of a situation where an inappropriate handover operation (HO to Wrong Cell) occurs in the wireless communication system according to the embodiment of the present invention.

With reference to FIG. 8, the wireless communication system further includes a wireless base station device 101C as compared to the wireless communication system shown in FIG. 1. The wireless base station device 101C is any of a femto base station, a pico base station, and a macro base station.

The wireless base station device 101C foil as a cell CC, and is capable of communicating with a wireless terminal device 202 existing in the cell CC by transmitting/receiving a radio signal to/from the wireless terminal device 202.

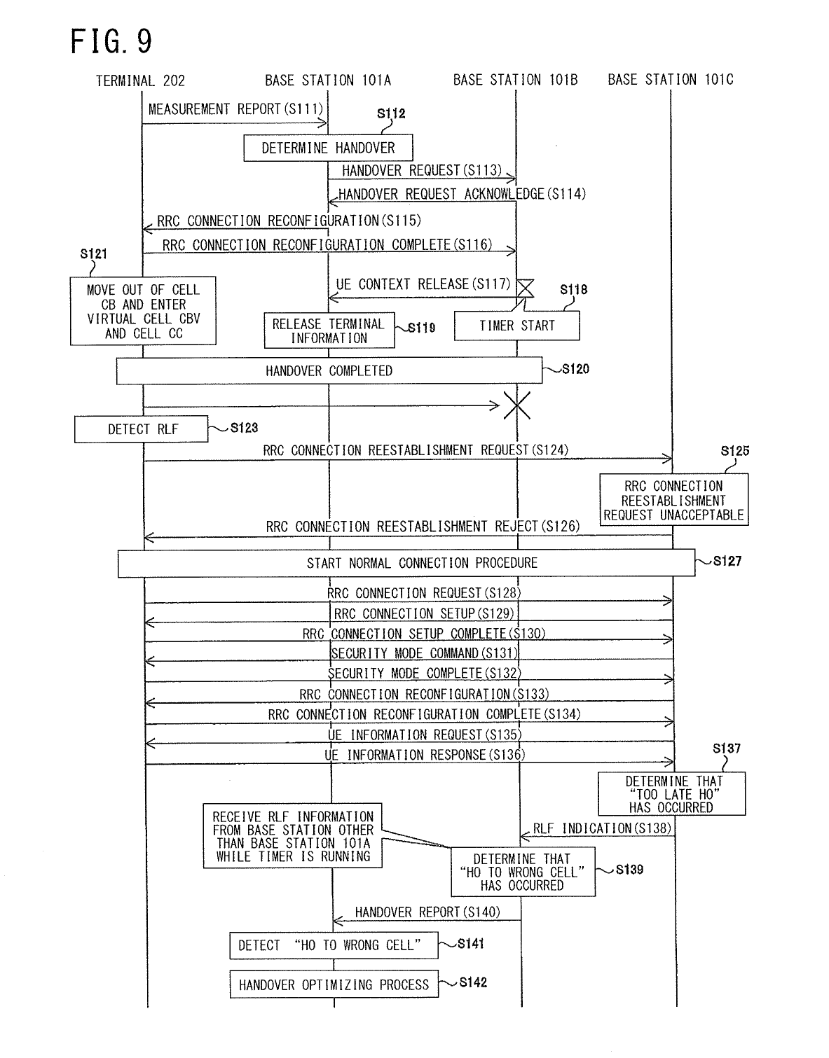

FIG. 9 is a diagram showing an inappropriate handover operation (HO to Wrong Cell) and an example of a sequence of a process for detecting the same, in the wireless communication system according to the embodiment of the present invention.

An example of “HO to Wrong Cell” is as follows. That is, after the wireless terminal device 202 has succeeded in connecting itself to the wireless base station device as the handover destination, an RLF occurs in a short time, and reestablishment of connection of the wireless terminal device 202 to a wireless base station device other than the wireless base station devices as the handover source and the handover destination occurs.

An example of a “HO to Wrong Cell” detection method is as follows. That is, in the case where the wireless base station device 101B as the handover destination has received an RLF report from the wireless base station device 101C other than the wireless base station device 101A as the handover source, if the wireless base station device 101B has transmitted, to the wireless base station device 101A, a UE context release instruction due to completion of handover of the wireless terminal device 202 to the wireless base station device 101B, within a predetermined time period prior to the reception timing, the wireless base station device 101B notifies the wireless base station device 101A that “HO to Wrong Cell” has occurred.

The wireless base station device 101B uses a timer to measure the predetermined time period. Thereby, when receiving the RLF report, the wireless base station device 101B can determine whether the RLF has occurred due to its “Too Late HO” or due to “HO to Wrong Cell” of the wireless base station device 101A.

It is now assumed that, as shown in FIG. 8, the wireless terminal device 202, being located in the cell CA and communicating with the wireless base station device 101A, moves to an overlap region of a virtual cell CBV and the cell CA (step S110). The virtual cell CBV is a virtual cell extended from the cell CB in accordance with an offset OST as a parameter, in order to promote handover from the wireless base station device 101A to the wireless base station device 101B. In this case, the offset OST is a parameter possessed by the wireless base station device 101A.

With reference to FIGS. 8 and 9, first, the wireless terminal device 202 measures the reception powers of the radio signals transmitted from the wireless base station devices, and transmits a measurement result notification indicating the measurement results of the reception powers to the wireless base station device 101A (step S111).

Next, based on the measurement result notification received from the wireless terminal device 202, the wireless base station device 101A determines whether or not handover of the wireless terminal device 202 should be performed. Upon determining that handover of the wireless terminal device 202 should be performed, the wireless base station device 101A determines, for example, the wireless base station device 101B as a handover destination with reference to neighboring cell information (step S112).

Next, the wireless base station device 101A transmits a handover request indicating the wireless base station device 101B to the wireless base station device 101B via an X2 interface as an inter-base-station interface (step S113).

Upon receiving the handover request from the wireless base station device 101A, the wireless base station device 101B transmits a handover response to the handover request, to the wireless base station device 101A via the X2 interface (step S114).

Upon receiving the handover response from the wireless base station device 101B, the wireless base station device 101A transmits an RRC connection reconfiguration instruction (RRC Connection Reconfiguration) to the wireless terminal device 202 (step S115).

When an RRC connection has been established between the wireless terminal device 202 and the wireless base station device 101B, the wireless terminal device 202 transmits an RRC connection reconfiguration completion notification (RRC Connection Reconfiguration Complete) to the wireless base station device 101B (step S116).

Upon receiving the RRC connection reconfiguration completion notification from the wireless terminal device 202, the wireless base station device 101B transmits a UE context release instruction to the wireless base station device 101A (step S117).

Further, the wireless base station device 101B starts the timer to measure the cell dwell time of the wireless terminal device 202 in the cell CB (step S118).

Upon receiving the UE context release instruction from the wireless base station device 101B, the wireless base station device 101A releases the information (UE Context) relating to the wireless terminal device 202 (step S119).

Thus, the handover of the wireless terminal device 202 from the wireless base station device 101A to the wireless base station device 101B is completed (step S120).

Before transmitting the measurement result notification (Measurement Report) to the wireless base station device 101B, the wireless terminal device 202 moves out of the range of the cell CB and enters the range of the virtual cell CBV and the cell CC (step S121).

Then, the wireless terminal device 202 is significantly subjected to interference of the radio signal transmitted from the wireless base station device 101C (Other eNB) and becomes incapable of communicating with the wireless base station device 101B, and therefore, an RLF occurs (step S123).

Upon detecting the occurrence of the RLF, the wireless terminal device 202 searches the neighboring wireless base station devices by, for example, measuring the reception powers of the radio signals. In this case, since the reception power of the radio signal from the wireless base station device 101C is largest, the wireless terminal device 202 transmits an RRC connection reestablishment request to the wireless base station device 101C to achieve reconnection to the found wireless base station device 101C (step S124).

Since the wireless base station device 101C does not have the information (UE Context) relating to the wireless terminal device 202, the wireless base station device 101C cannot accept the RRC connection reestablishment request from the wireless terminal device 202 (step S125). Therefore, the wireless base station device 101C transmits an RRC connection reestablishment rejection to the wireless terminal device 202 (step S126).

Upon receiving the RRC connection reestablishment rejection from the wireless base station device 101C, the wireless terminal device 202 starts a usual connection procedure with the wireless base station device 101C (step S127).

That is, first, the wireless terminal device 202 transmits an RRC connection request to the wireless base station device 101C (step S128).

Upon receiving the RRC connection request from the wireless terminal device 202, the wireless base station device 101C transmits RRC connection information (RRC Connection Setup) to the wireless terminal device 202 (step S129).

Upon receiving the RRC connection information from the wireless base station device 101C, the wireless terminal device 202 transmits an RRC connection completion notification (RRC Connection Setup Complete) (step S130).

Upon receiving the RRC connection completion notification from the wireless terminal device 202, the wireless base station device 101C transmits security information (Security Mode Command) to the wireless terminal device 202 (step S131).

Upon receiving the security information from the wireless base station device 101C, the wireless terminal device 202 transmits security completion notification (Security Mode Complete) to the wireless base station device 101C (step S132).

Next, the wireless base station device 101C transmits an RRC connection reconfiguration instruction (RRC Connection Reconfiguration) to the wireless terminal device 202 (step S133).

When an RRC connection has been established between the wireless terminal device 202 and the wireless base station device 101C, the wireless terminal device 202 transmits an RRC connection reconfiguration completion notification (RRC Connection Reconfiguration Complete) to the wireless base station device 101C (step S134).

The RRC connection completion notification and the RRC connection reconfiguration completion notification each include, for example, a parameter “rlf-InfoAvailable”. The wireless terminal device 202 specifies this parameter in each of the RRC connection completion notification and the RRC connection reconfiguration completion notification, and transmits the notification. Thereby, the wireless base station device 101C recognizes that an RLF has occurred with respect to the wireless terminal device 202. In order to acquire detailed information about the RLF, the wireless base station device 101C transmits a UE context request (UE Information Request) to the wireless terminal device 202 (step S135).

Upon receiving the UE context request from the wireless base station device 101C, the wireless terminal device 202 transmits a UE context response (UE Information Response) including an RLF report to the wireless base station device 101C (step S136). The RLF report includes: the PCI of the wireless base station device in which the RLF has occurred; the PCI and ECGI of the wireless base station device in which the RRC connection reestablishment has occurred; and the C-RNTI of the wireless terminal device 202. The PCI for which the RLF has occurred corresponds to the ID of the wireless base station device 101B, the PCI and ECGI for which the RRC connection reestablishment has occurred correspond to the ID of the wireless base station device 101C, and the C-RNTI corresponds to the ID assigned by the wireless base station device 101B.

Next, with reference to the PCIs in the RLF report received from the wireless terminal device 202, the wireless base station device 101C recognizes that an RLF has occurred in the wireless base station device 101B, and determines that “Too Late HO” to the cell CC has occurred (step S137).

Next, in order to notify the “Too Late HO”, the wireless base station device 101C transmits an RLF notification (RLF INDICATION) including the content of the RLF report, to the wireless base station device 101B via the X2 interface (step S138).

Upon receiving the RLF notification from the wireless base station device 101C, the wireless base station device 101B checks the timer that has been started. If the timer is running, i.e., if a predetermined time period has not elapsed from when the timer was started, the wireless base station device 101B determines that “Too Late HO” to the cell CC has not occurred. Further, since the wireless base station device 101B has received the RLF notification from the wireless base station device 101C other than the wireless base station device 101A, the wireless base station device 101B determines that not “Too Early HO” to the cell CB but “HO to Wrong Cell” to the cell CB has occurred. If the timer is not running when the wireless base station device 101B receives the RLF notification from the wireless base station device 101C, i.e., if the above-mentioned predetermined time period has elapsed from when the timer was started, the wireless base station device 101B determines that “Too Late HO” to the cell CC has occurred.

Upon determining that “HO to Wrong Cell” to the cell CB has occurred (step S139), the wireless base station device 101B transmits a handover report to the wireless base station device 101A (step S140). This handover report includes a parameter “Handover Report Type”, for example. The wireless base station device 101B sets this parameter to a specific value to notify the wireless base station device 101A of the “HO to Wrong Cell”.

Upon receiving the handover report from the wireless base station device 101B, the wireless base station device 101A recognizes that “HO to Wrong Cell” to the cell CB has occurred (step S141), and performs a handover operation optimizing process so as to suppress occurrence of “HO to Wrong Cell” (step S142).

In addition to the above-mentioned “Too Late HO”, “Too Early HO”, and “HO to Wrong Cell”, there is “Ping Pong HO” as an inappropriate handover operation.

The “Ping Pong HO” means a case where each of two wireless base station devices determines that a certain wireless terminal device has performed handover to the other wireless base station device. When such “Ping Pang HO” has occurred, although connection between the wireless terminal device and each wireless base station device is not disconnected, the process for the handover operation is repeated for the wireless terminal device, which disables phone call and data transmission. In addition, the load on the upper network is increased.

[Handover Operation Control Parameters]

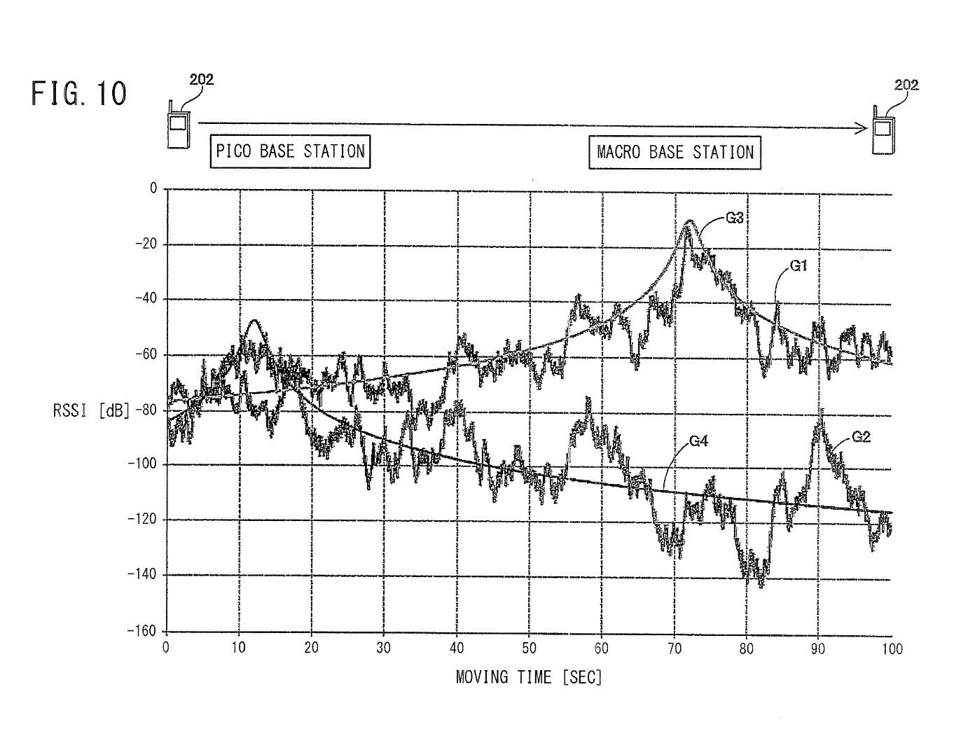

FIG. 10 is a diagram showing a simulation result of reception quality of a wireless terminal device in the wireless communication system according to the embodiment of the present invention.

FIG. 10 shows an RSSI (Received Signal Strength Indication) of a wireless terminal device 202 in 100 sec during which the wireless terminal device 202 passes near a pico base station and thereafter passes near a macro base station, at 30 km per hour.

In FIG. 10, graphs G1 and G3 each show an RSSI of a radio signal transmitted from the macro base station, and graphs G2 and G4 each show an RSSI of a radio signal transmitted from the pico base station. The graphs G1 and G2 each show a simulation result taking into account shadowing, i.e., a temporal change in the reception power of the radio signal in the wireless terminal device 202, which is caused by changes in relative positions between the wireless terminal device 202 and the other objects. The graphs G3 and G4 each show a simulation result not taking into account such shadowing.

With reference to FIG. 10, an ideal position of handover of the wireless terminal device 202 from the pico base station to the macro base station is near an intersection of the graphs, i.e., a position at which the moving time of the wireless terminal device 202 is about 17 sec. However, actually, it is difficult to know the future communication environment of the wireless terminal device 202 in the wireless communication system. Therefore, it is important to optimize the handover operation by adjusting the timing of the handover operation based on the results of various measurements and the like.

Further, in the period corresponding to the moving time from 15 sec to 20 sec, the high and low powers of the radio signals from the respective wireless base station devices coexist, and therefore, for example, “Too Early HO” or “Ping Pong HO” is more likely to occur. Further, at and near the timing when the moving time is 20 sec, the reception power of the radio signal from the pico base station is sharply reduced while the reception power of the radio signal from the macro base station is sharply increased, and thereby the SINR (Signal to Interference-plus-Noise Ratio) is rapidly deteriorated, which makes “Too Late HO” more likely to occur.

Assuming that an evaluation function of MRO (Mobility Robustness Optimization) for handover optimization which is defined in 3GPP is Y=MRO(X), Y is any of the following: the frequency of occurrence of “Too Late HO”; the frequency of occurrence of “Too Early HO”; the frequency of occurrence of “HO to Wrong Cell”; the frequency of occurrence of unnecessary handover such as “Ping Pong HO”; and the frequency of occurrence of handover immediately after RRC connection information has been transmitted, that is, immediately after the wireless terminal device 202 has been connected to a wireless base station device.

In addition, X is, tor example, a parameter for a power measurement process (Measurement), and the parameter is any of the following: hysteresis HS: 0 dB to +15 dB; TTT (Time to Trigger): 0 ms to 5120 ms; and offset OST (Cell Individual Offset): −24 dB to +24 dB. Alternatively, X is a parameter for a cell reselection process.

For example, the hysteresis HS and the TTT can be set for each event described later, the offset OST can be set for each serving cell formed by a serving base station or for each neighboring cell, and gap MG and filtering coefficient α, described later, can be set for each serving cell.

It is now assumed that a wireless base station device determines handover upon receiving a measurement result notification (Measurement Report), in order to reduce an uplink transmission load on the wireless terminal device 202. That is, the transmission timing of the measurement result notification corresponds to the timing of the handover.

Hereinafter, a description will be given of the relationships between various events of transmitting a measurement result notification and the parameters for the power measurement process.

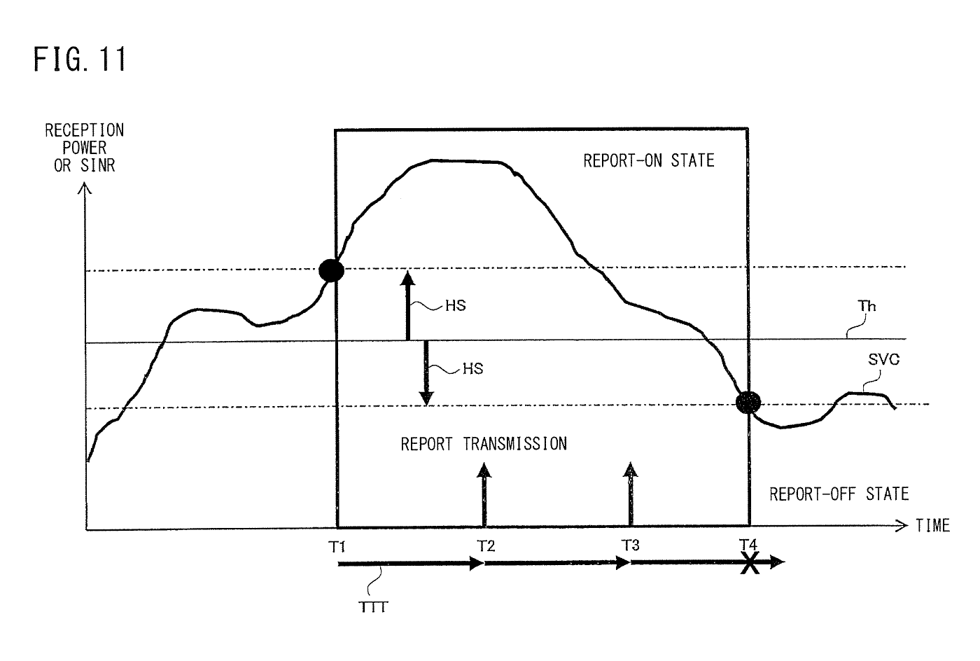

FIG. 11 is a diagram showing an event A1 in which a wireless terminal device transmits a measurement result notification, in the wireless communication system according to the embodiment of the present invention. In FIG. 11, the horizontal axis indicates time, and the vertical axis indicates the reception power or SINR of a radio signal in a wireless terminal device 202. In addition, SVC indicates the reception power or SINR of a serving cell, that is, the reception power or SINR of a radio signal transmitted from a serving base station.

With reference to FIG. 11, in the event A1, a hysteresis HS is set in each of positive and negative directions with respect to a threshold Th.

When the reception power or SINR of the serving cell becomes larger than (Th+HS), the wireless terminal device 202 transits to a report-on state (timing T1).

When TTT has elapsed from timing T1 in the state where the condition that the reception power or SINR is larger than (Th−HS) is satisfied, the wireless terminal device 202 transmits a measurement result notification (timing T2).

When TTT has elapsed from timing T2 in the state where the above condition is satisfied, the wireless terminal device 202 transmits a measurement result notification (timing T3).

If the above condition becomes unsatisfied before TTT elapses from timing T3, the wireless terminal device 202 does not transmit a measurement result notification, and transits to a report-off state (timing T4).

The wireless terminal device 202 performs the power measurement process regardless of its transition between the report-on state and the report-off state, for example, periodically, and transmits a most recent measurement result as a measurement result notification. Further, for example, the wireless terminal device 202 transits between the report-on state and the report-off state independently for each of the reception power and the SINR. That is, the wireless terminal device 202 transmits a measurement result notification when the condition of either the reception power or the SINR is satisfied.

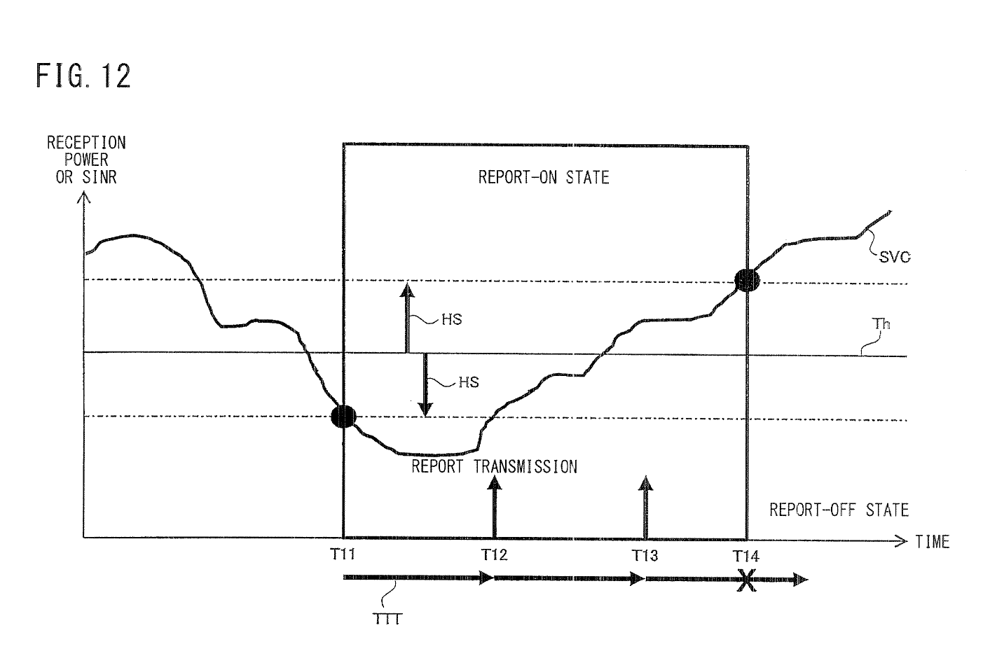

FIG. 12 is a diagram showing an event A2 in which a wireless terminal device transmits a measurement result notification, in the wireless communication system according to the embodiment of the present invention. The way to see the figure is identical to that of FIG. 11.

With reference to FIG. 12, in the event A2, a hysteresis HS is set in each of positive and negative directions with respect to a threshold Th.

When the reception power or SINR of the serving cell becomes smaller than (Th−HS), the wireless terminal device 202 transits to the report-on state (timing T11).

When TTT has elapsed from timing T11 in the state where the condition that the reception power or SINR is smaller than (Th+HS) is satisfied, the wireless terminal device 202 transmits a measurement result notification (timing T12).

When TTT has elapsed from timing T12 in the state where the above condition is satisfied, the wireless terminal device 202 transmits a measurement result notification (timing T13).

If the above condition becomes unsatisfied before TTT elapses from timing T13, the wireless terminal device 202 does not transmit a measurement result notification, and transits to the report-off state (timing T14).

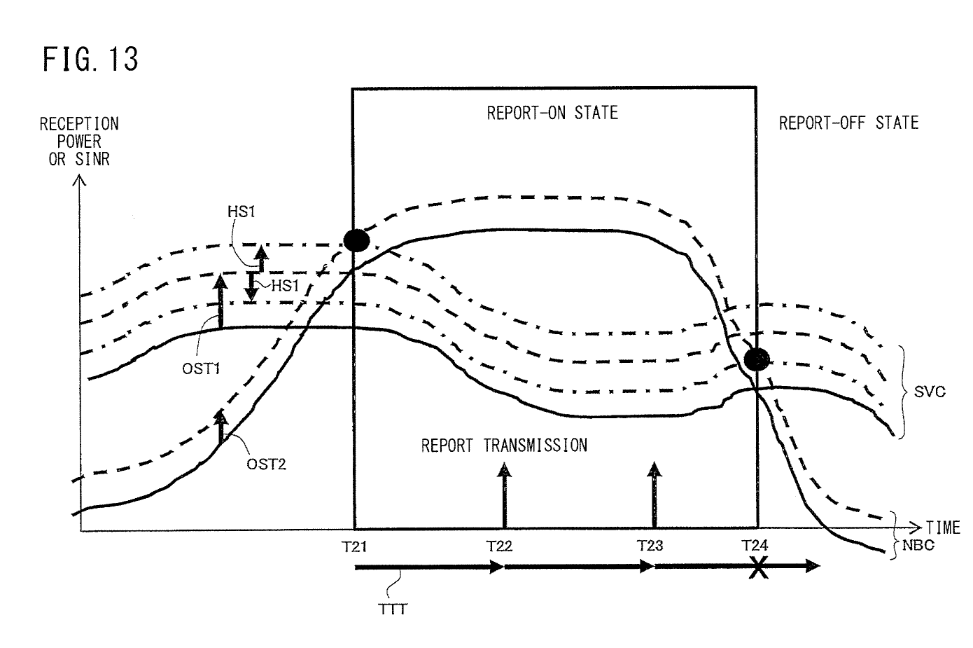

FIG. 13 is a diagram showing an event A3 in which a wireless terminal device transmits a measurement result notification, in the wireless communication system according to the embodiment of the present invention. In FIG. 13, the horizontal axis indicates time, and the vertical axis indicates the reception power or SINR of a radio signal in a wireless terminal device 202. In addition, SVC indicates the reception power or SINR of a serving cell, and NBC indicates the reception power or SINR of a neighboring cell, that is, the reception power or SINR of a radio signal transmitted from a neighboring base station.

With reference to FIG. 13, in the event A3, an offset OST1 is set in the positive direction with respect to the reception power or SINR of the serving cell, and a hysteresis HS is set in each of the positive and negative directions. In addition, an offset OST2 is set in the positive direction with respect to the reception power or SINR of the neighboring cell.

When {(reception power or SINR of neighboring cell)+OST2} becomes larger than {(reception power or SINR of serving cell)+OST1+HS}, the wireless terminal device 202 transits to the report-on state (timing T21).

When TTT has elapsed from timing T21 in the state where the condition that {(reception power or SINR of neighboring cell)+OST2} is larger than {(reception power or SINR of serving cell)+OST1−HS} is satisfied, the wireless terminal device 202 transmits a measurement result notification (timing T22).

When TTT has elapsed from timing T22 in the state where the above condition is satisfied, the wireless terminal device 202 transmits a measurement result notification (timing T23).

If the above condition becomes unsatisfied before TTT elapses from timing T23, the wireless terminal device 202 does not transmit a measurement result notification, and transits to the report-off state (timing T24).

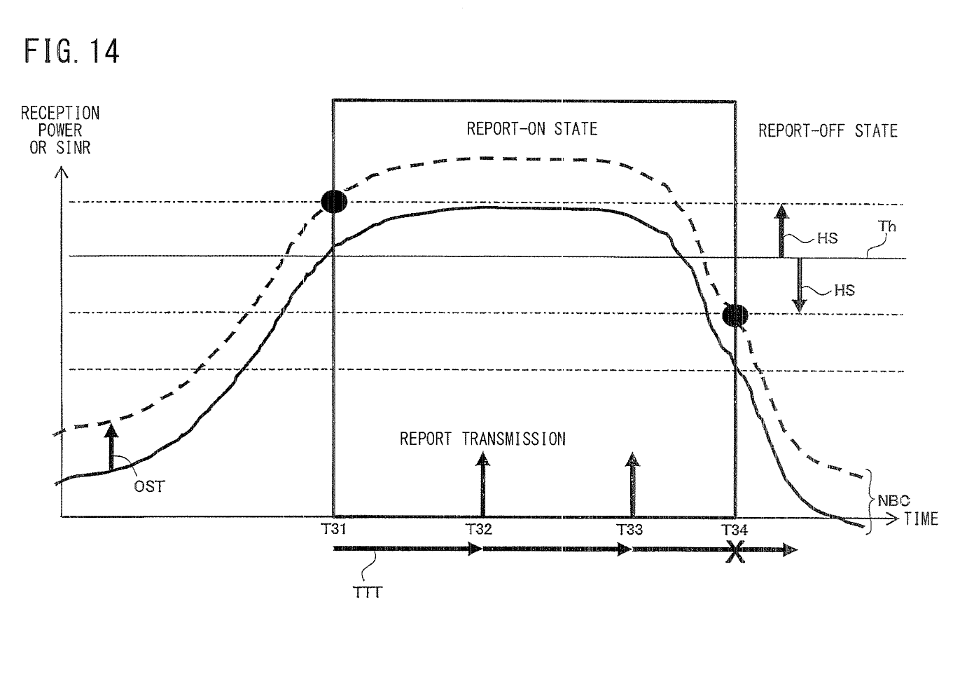

FIG. 14 is a diagram showing an event A4 in which a wireless terminal device transmits a measurement result notification, in the wireless communication system according to the embodiment of the present invention. The way to see the figure is identical to that for FIG. 13.

With reference to FIG. 14, in the event A4, an offset OST is set in the positive direction with respect to the reception power or SINR of a neighboring cell, and a hysteresis HS is set in each of the positive and negative directions with respect to a threshold Th.

When {(reception power or SINR of neighboring cell)+OST} becomes larger than (Th+HS), the wireless terminal device 202 transits to the report-on state (timing T31).

When TTT has elapsed from timing T31 in the state where the condition that {(reception power or SINR of neighboring cell)+OST} is larger than (Th−HS) is satisfied, the wireless terminal device 202 transmits a measurement result notification (timing T32).

When TTT has elapsed from timing T32 in the state where the above condition is satisfied, the wireless terminal device 202 transmits a measurement result notification (timing T33).

If the above condition becomes unsatisfied before TTT elapses from timing T33, the wireless terminal device 202 does not transmit a measurement result notification, and transits to the report-off state (timing T34).

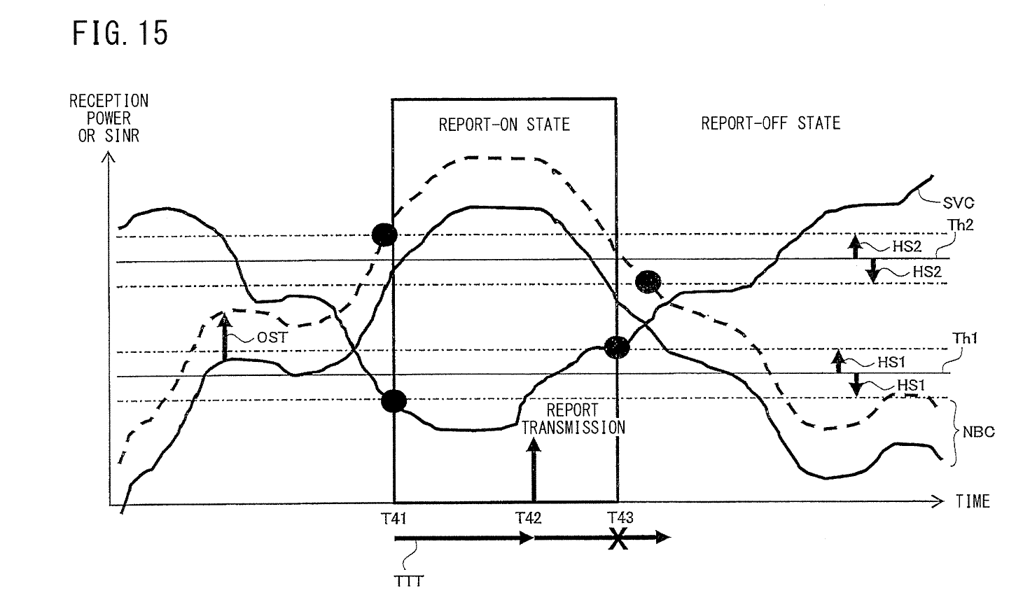

FIG. 15 is a diagram showing an event A5 in which a wireless terminal device transmits a measurement result notification, in the wireless communication system according to the embodiment of the present invention. The way to see the figure is identical to that for FIG. 13.

With reference to FIG. 15, in the event A5, an offset OST is set in the positive direction with respect to the reception power or SINR of a neighboring cell, a hysteresis HS1 is set in each of the positive and negative directions with respect to a threshold Th1, and a hysteresis HS2 is set in each of the positive and negative directions with respect to a threshold Th2.

When the reception power or SINR of a serving cell becomes smaller than (Th1−HS1) and {(reception power or SINR of neighboring cell)+OST} becomes larger than (Th2+HS2), the wireless terminal device 202 transits to the report-on state (timing T41).

When TTT has elapsed from timing T41 in the state where the condition that the reception power or SINR of the serving cell is smaller than (Th1+HS1) and {(reception power or SINR of neighboring cell)+OST} is larger than (Th2−HS2) is satisfied, the wireless terminal device 202 transmits a measurement result notification (timing T42).

When the above condition becomes unsatisfied before ITT elapses from timing T42, the wireless terminal device 202 does not transmit a measurement result notification, and transits to the report-off state (timing T43).

As described above, by adjusting the parameters described with respect to the events A1 to A5, that is, the hysteresis HS, the TTT, and the offset OST, it is possible to control the timing of the handover operation of the wireless terminal device 202.

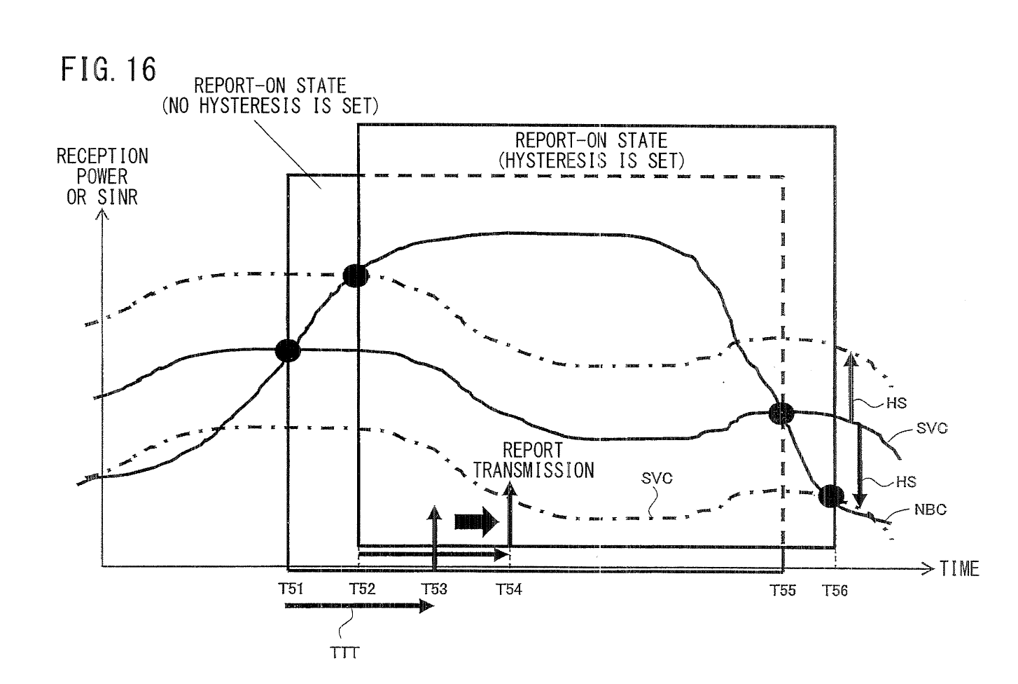

FIG. 16 is a diagram showing handover operation timing control by adjusting the hysteresis HS, in the wireless communication system according to the embodiment of the present invention. FIG. 16 shows the case of the event A3.

With reference to FIG. 16, when the hysteresis HS is set to zero, the wireless terminal device 202 transits to the report-on state at timing T51, transmits a measurement result notification at timing T53, and transits to the report-off state at timing T55.

On the other hand, when the hysteresis HS is set to be larger than zero, the wireless terminal device 202 transits to the report-on state at timing T52 later than timing T51, transmits a measurement result notification at timing T54 later than timing T53, and transits to the report-off state at timing T56 later than timing T55.

That is, by increasing the hysteresis HS, the transmission timing of the measurement result notification, i.e., the timing of the handover operation can be delayed.

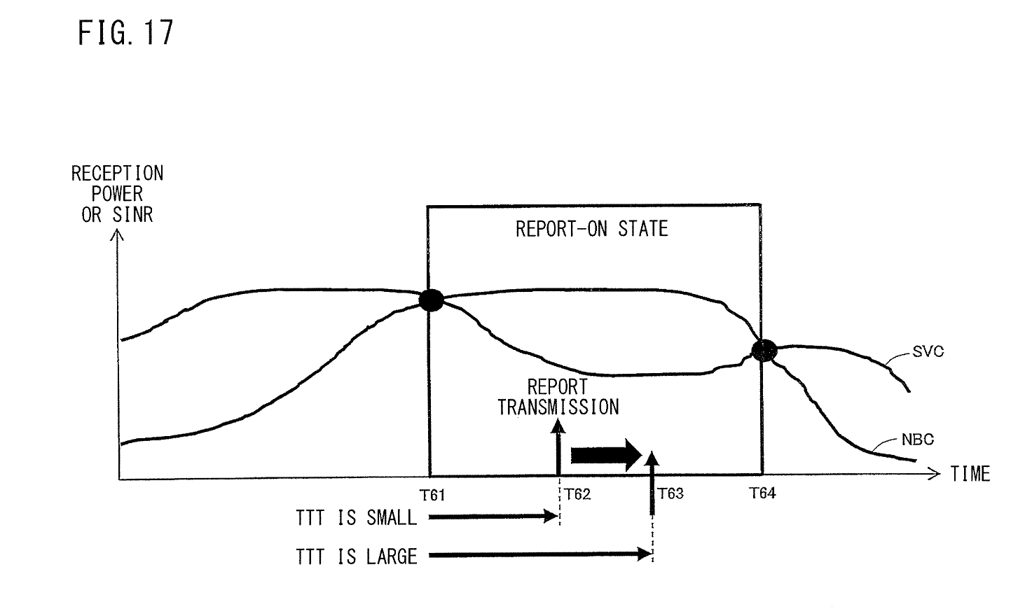

FIG. 17 is a diagram showing handover operation timing control by adjusting the TTT, in the wireless communication system according to the embodiment of the present invention. FIG. 17 shows the case of the event A3.

With reference to FIG. 17, when the TTT is set to be small, a measurement result notification is transmitted at timing T62.

On the other hand, when the TTT is set to be large, a measurement result notification is transmitted at timing T63 later than timing T61.

That is, by increasing the TTT, the transmission timing of the measurement result notification, i.e., the timing of the handover operation can be delayed.

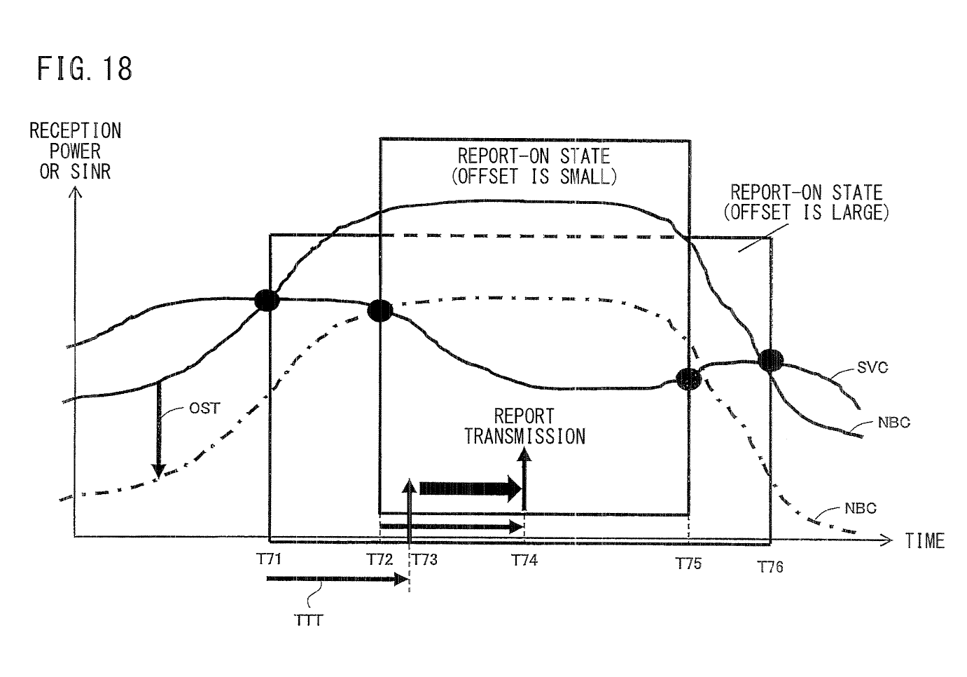

FIG. 18 is a diagram showing handover operation timing control by adjusting the offset OST, in the wireless communication system according to the embodiment of the present invention. FIG. 18 shows the case of the event A3.

With reference to FIG. 18, when the offset OST is set to zero, the wireless terminal device 202 transits to the report-on state at timing T71, transmits a measurement result notification at timing T73, and transits to the report-off state at timing T76.

On the other hand, when the offset OST is set to be smaller than zero, the wireless terminal device 202 transits to the report-on state at timing T72 later than timing T71, transmits a measurement result notification at timing T74 later than timing T73, and transits to the report-off state at timing T76 prior to timing 176.

That is, by reducing the offset OST, the transmission timing of the measurement result notification, i.e., the timing of the handover operation can be delayed. Further, the transition from the report-off state to the report-on state is delayed, and the transition from the report-on state to the report-off state is advanced.

As described above, by increasing the hysteresis HS or the TTT or by reducing the offset OST, the timing of the handover operation is delayed. That is, the time during which the wireless terminal device 202 is connected to the serving base station is increased. Therefore, the frequencies of occurrences of “Too Early HO”, “HO to Wrong Cell”, and “Ping Pong HO” are reduced, and the frequency of occurrence of “Too Late HO” is increased.

Hereinafter, how the effects differ among the adjustments of the hysteresis HS, the TTT, and the offset OST will be considered.

Although the handover timing can be adjusted by adjusting any of the parameters, the effects achieved by the adjustments of the respective parameters differ depending on the landform including interference, the moving velocity of the wireless terminal device, and the like.

Adjusting the hysteresis HS or the offset OST corresponds to adjusting the position where handover is performed, by virtually increasing or reducing the cell. For example, the hysteresis HS of the serving cell is increased to make the reception power of the radio signal look greater, thereby making handover to another cell unlikely to occur. Alternatively, the offset OST of the neighboring cell is set to a negative value to make the reception power of the radio signal from the neighboring cell look smaller, thereby making handover to another cell unlikely to occur.

Further the hysteresis HS and the offset OST are parameters that are unlikely to be influenced by the moving velocity of the wireless terminal device.

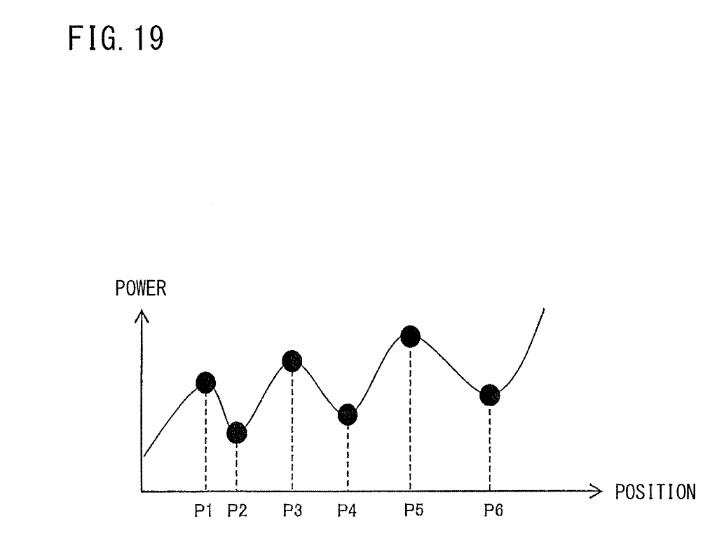

FIG. 19 is a diagram showing an example of the reception powers of a radio signal at different positions, in the wireless communication system according to the embodiment of the present invention.

With reference to FIG. 19, at positions P1, P3, and P5 where the reception power has the maximum value, it is preferred to adjust the timing of the handover operation by adjusting the hysteresis HS. At positions P2, P4, and P6 where the reception power has the minimum value, it is preferred to adjust the timing of the handover operation by adjusting the offset OST.

On the other hand, the TTT is a parameter that can delay the timing of the handover operation in the time domain. In the case of adjusting the TTT, the timing of the handover operation does not depend on the radio environment and the landform, but instead the position where handover is performed greatly varies depending on the moving velocity of the wireless terminal device 202. For example, if the TTT is set to be excessively large, handover failure is more likely to occur because the change of the radio environment surrounding the wireless terminal device that moves at high speed is great.

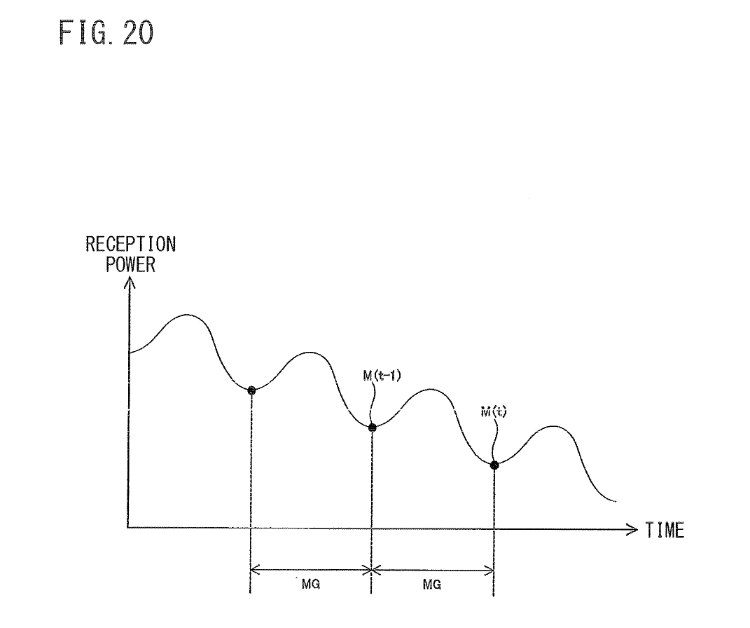

FIG. 20 is a diagram for explaining other examples of parameters for controlling the timing of the handover operation, in the wireless communication system according to the embodiment of the present invention.

With reference to FIG. 20, the wireless terminal device 202 measures the reception power of a radio signal transmitted from a wireless base station device, for example, at time intervals of gap MG.

When the gap MG is increased, the more previous reception power is used for determination of handover, and thereby the timing of the handover operation is delayed. On the other hand, when the gap MG is reduced, the more recent reception power is used for determination of handover, and thereby the timing of the handover operation is advanced.

By reducing the gap MG, appropriate handover based on the more recent reception power can be performed. On the other hand, by increasing the gap MG, the processing load on the wireless terminal device 202 can be reduced.

Further, the wireless terminal device 202 calculates a reception power MR(t) expressed by the following equation, based on, for example, a reception power M(t−1) measured at time (t−1), a reception power M(t) measured at time t later than the time (t−1), and a filtering coefficient α.

MR(t)=α×M(t−1)+(1−α)×M(t)

The wireless terminal device 202 transmits a measurement result notification indicating the reception power MR(t) to the wireless base station device.

When the filtering coefficient α is increased, the more previous reception power is reflected in the measurement result notification, and therefore, the timing of the handover operation is delayed. On the other hand, when the filtering coefficient α is reduced, the more recent reception power is reflected in the measurement result notification, and thereby the timing of the handover operation is advanced.

In a measurement start request (Measurement Configuration) and an RRC connection reconfiguration instruction (RRC Connection Reconfiguration) to be transmitted from a wireless base station device to the wireless terminal device 202, for example, an offset OST is set for each neighboring cell, at least one of the events A1 to A5 is set, and a hysteresis HS and a TTT corresponding to the set event(s) are set. Further, in the measurement start request, a gap MG and a filtering coefficient α are set for each serving cell.

[Wireless Base Station Device]

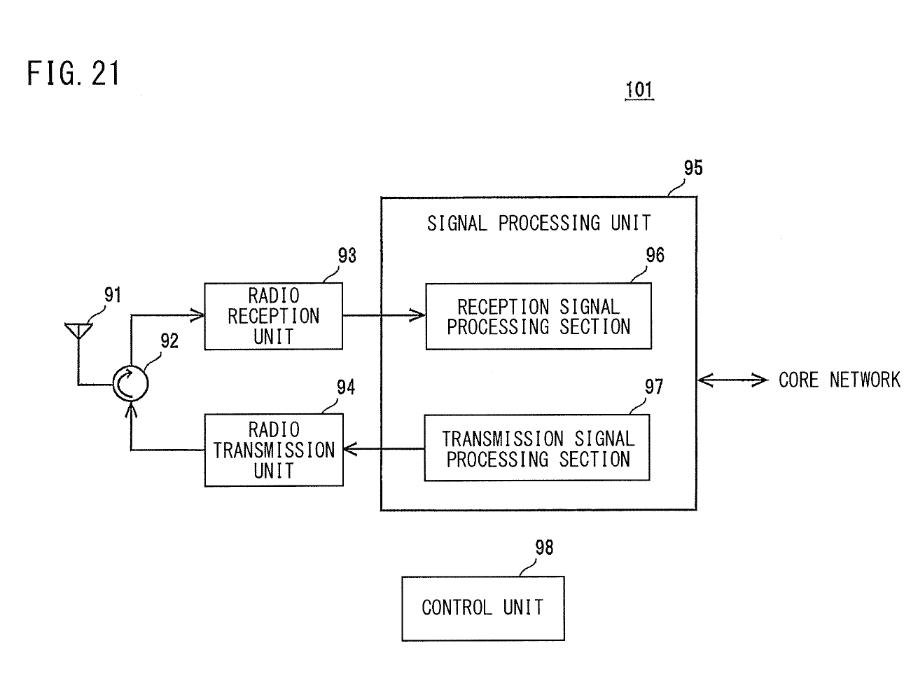

FIG. 21 is a diagram showing the configuration of a wireless base station device according to the embodiment of the present invention.

With reference to FIG. 21, a wireless base station device 101 includes an antenna 91, a circulator 92, a radio reception unit 93, a radio transmission unit 94, a signal processing unit 95, and a control unit 98. The signal processing unit 95 includes a reception signal processing section 96 and a transmission signal processing section 97. The signal processing unit 95 and the control unit 98 are each implemented by a CPU (Central Processing Unit), a DSP (Digital Signal Processor), or the like.

The circulator 92 outputs, to the radio reception unit 93, a radio signal transmitted from a wireless terminal device 202 and received by the antenna 91. Further, the circulator 92 outputs, to the antenna 91, a radio signal received from the radio transmission unit 94.

The radio reception unit 93 frequency-converts the radio signal received from the circulator 92 into a baseband signal or an IF (Intermediate Frequency) signal, and converts the frequency-converted signal into a digital signal, and then outputs the digital signal to the reception signal processing section 96.

The reception signal processing section 96 performs signal processing such as inverse diffusion based on CDMA (Code Division Multiple Access) on the digital signal received from the radio reception unit 93, and converts a part or the entirety of the processed digital signal into a predetermined frame format, and then outputs the resultant signal to the core network side.

The transmission signal processing section 97 performs signal processing such as IFFT (Inverse Fast Fourier Transform) based on OFDM (Orthogonal Frequency Division Multiplex) on communication data obtained by converting communication data received from the core network side into a predetermined frame format or on communication data generated by itself, and then outputs a digital signal obtained by the signal processing to the radio transmission unit 94.

The radio transmission unit 94 converts the digital signal received from the transmission signal processing section 97 into an analog signal, and frequency-converts the analog signal into a radio signal, and then outputs the radio signal to the circulator 92.

The control unit 98 exchanges various kinds of information with the respective units in the wireless base station device 101 and with the core network.

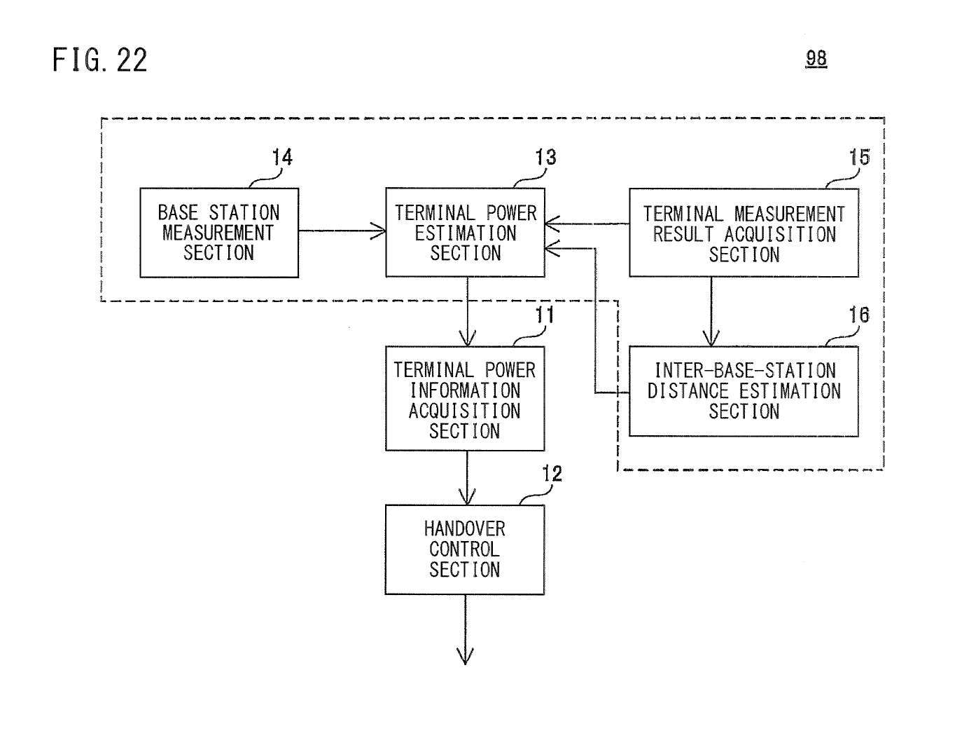

FIG. 22 is a diagram showing the configuration of the control unit in the wireless base station device according to the embodiment of the present invention.

With reference to FIG. 22, the control unit 98 includes a terminal power information acquisition section 11, a handover control section (moving operation control section) 12, a terminal power estimation section 13, a base station measurement section 14, a terminal measurement result acquisition section 15, and an inter-base-station distance estimation section 16.

The terminal power information acquisition section 11 acquires terminal power information indicating a degree of change (hereinafter also referred to as a power change amount PC) in the reception power of a radio signal in a wireless terminal device 202 existing in the range of a cell formed by the own wireless base station device, with respect to a positional change of the wireless terminal device 202. The degree of change may be expressed simply by terms such as “large” and “small”, or may be expressed by numerical values.

When considering at which position in the wireless communication system 301 the terminal power information acquisition section 11 should acquire the power change amount PC, the terminal power information acquisition section 11 is preferably configured to acquire the power change amount PC in the state where an index, such as SINR, indicating the reception quality of a radio signal transmitted from the own wireless base station device is equal to or smaller than a predetermined value in the wireless terminal device 202. Alternatively, the terminal power information acquisition section 11 is preferably configured to acquire the terminal power information indicating the power change amount PC in the state where the reception power of a radio signal transmitted from another wireless base station device is equal to or higher than a predetermined threshold in the wireless terminal device 202.

Based on the terminal power information acquired by the terminal power information acquisition section 11, the handover control section 12 controls the timing of a handover operation of the wireless terminal device 202 from the own wireless base station device to the another wireless base station device.

More specifically, the handover control section 12 controls the timing of the handover operation to be advanced when the power change amount PC indicated by the terminal power information is large, and controls the timing of the handover operation to be delayed when the power change amount PC is small.

Further, the handover control section 12 sets the control width for the timing of the handover operation, i.e., the parameter change width, to be large when the power change amount PC indicated by the terminal power information is large, and sets the control width for the timing of the handover operation to be small when the power change amount PC is small.

The handover control section 12 outputs control information indicating the set parameter to the transmission signal processing section 97.

The transmission signal processing section 97 includes, in communication data, the parameter indicated by the control information received from the handover control section 12, and transmits the communication data to the radio transmission unit 94.

Based on the radio signal received by the radio reception unit 93, the base station measurement section 14 measures the reception power and frequency of the radio signal received from the wireless terminal device 202, and the reception power and the like of the radio signal transmitted from the another wireless base station device.

The inter-base-station distance estimation section 16 estimates an inter-base-station distance R between the own wireless base station device and the another wireless base station device, based on a downlink path loss which is a difference between the transmission power of the radio signal transmitted from the another wireless base station device, and the reception power, in the cell formed by the own wireless base station device, of the radio signal transmitted from the another wireless base station device.

The terminal measurement result acquisition section 15 acquires a measurement result notification transmitted from the wireless terminal device 202, by using the signal processing result of the reception signal processing section 96.

The inter-base-station distance estimation section 16 acquires the reception power, in the cell formed by the own wireless base station device, of the radio signal from the another wireless base station device, with reference to the measurement result notification acquired by the terminal measurement result acquisition section 15, for example. The inter-base-station distance estimation section 16 may be configured to, if the radius of the cell of the own wireless base station device is small, acquire the reception power of the radio signal from the another wireless base station device, which is measured by the base station measurement section 14, instead of the reception power indicated by the measurement result notification.

The terminal power estimation section 13 estimates the power change amount PC based on the inter-base-station distance R estimated by the inter-base-station distance estimation section 16.

The terminal power information acquisition section 11 acquires, as terminal power information, the power change amount PC estimated by the terminal power estimation section 13.

Alternatively, the terminal power estimation section 13 estimates the power change amount PC based on a transmission power difference PD between the radio signal transmitted from the own wireless base station device and the radio signal transmitted from the another wireless base station device.

Alternatively, the terminal power estimation section 13 estimates the power change amount PC based on the moving velocity of the wireless terminal device 202 existing in the range of the cell formed by the own wireless base station device. The moving velocity of the wireless terminal device 202 means the physical moving velocity of the wireless terminal device 202, for example, speed per hour [km/h].

Alternatively, the terminal power estimation section 13 estimates the power change amount PC based on a temporal change in the downlink path loss which is a difference between the transmission power of the radio signal transmitted from the another wireless base station device, and the reception power, in the cell formed by the own wireless base station device, of the radio signal transmitted from the another wireless base station device.

Alternatively, the terminal power estimation section 13 estimates the power change amount PC based on a temporal change in an uplink path loss which is a difference between the transmission power of the radio signal transmitted from the wireless terminal device 202 existing in the range of the cell formed by the own wireless base station device, and the reception power of the radio signal in the own wireless base station device.

Alternatively, the terminal power estimation section 13 estimates the power change amount PC based on a Doppler shift which is a difference between the frequency of the radio signal transmitted from the wireless terminal device 202 existing in the range of the cell formed by the own wireless base station device, and the frequency of the radio signal received by the own wireless base station device.

Alternatively, the terminal power estimation section 13 estimates the power change amount PC based on shadowing which is a temporal change in the reception power of the radio signal in the wireless terminal device 202.

For example, the terminal power estimation section 13 acquires a temporal change in the reception power, based on the measurement result of the reception power of the radio signal in the wireless terminal device 202 existing in the range of the cell formed by the own wireless base station device, with reference to the measurement result notification acquired by the terminal measurement result acquisition section 15.

Alternatively, for example, the terminal power estimation section 13 estimates the power change amount PC, based on a temporal change in the reception power of a wireless terminal device 202 having a high moving velocity among a plurality of wireless terminal devices 202 existing in the range of the cell formed by the own wireless base station device.

The components enclosed by a broken line in FIG. 22, i.e., the terminal power estimation section 13, the base station measurement section 14, the terminal measurement result acquisition section 15, and the inter-base-station distance estimation section 16, are not essential components of the present invention. Even if the wireless base station device 101 does not include these components, it is possible to achieve the object of the present invention, i.e., stabilization of communication by appropriately controlling the moving operation of the wireless terminal device.

[Handover Operation Optimizing Process]

Hereinafter, the operation of the wireless base station device according to the embodiment of the present invention when performing a handover operation optimizing process will be described in detail.

The following will describe, as an example, timing control for a handover operation of a wireless terminal device 202 from a femto base station to a macro base station by the femto base station. However, the combination of the types of the base stations is not limited to this example, and other combinations may be adopted.

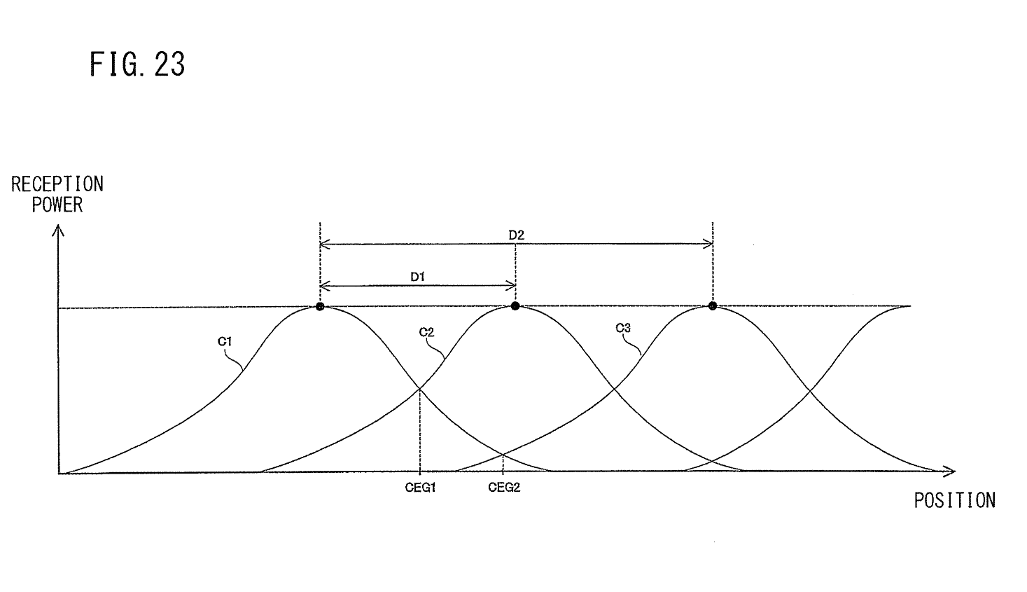

FIG. 23 is a diagram for explaining how the power change amount differs depending on the inter-base-station distance. In FIG. 23, the horizontal axis indicates the position of the wireless terminal device 202, and the vertical axis indicates the reception power of a radio signal in the wireless terminal device 202.

With reference to FIG. 23, cells C1 to C3 have the same transmission power. In this case, the power change amount PC is larger at a cell edge CEG1 between the cell C1 and the cell C2 whose peak positions are apart from each other by a distance D1 than at a cell edge CEG2 between the cell C1 and the cell C3 whose peak positions are apart from each other by a distance D2 that is larger than the distance D1.

The wireless base station device according to the embodiment of the present invention performs parameter adjustment by using the above relationship, for example.

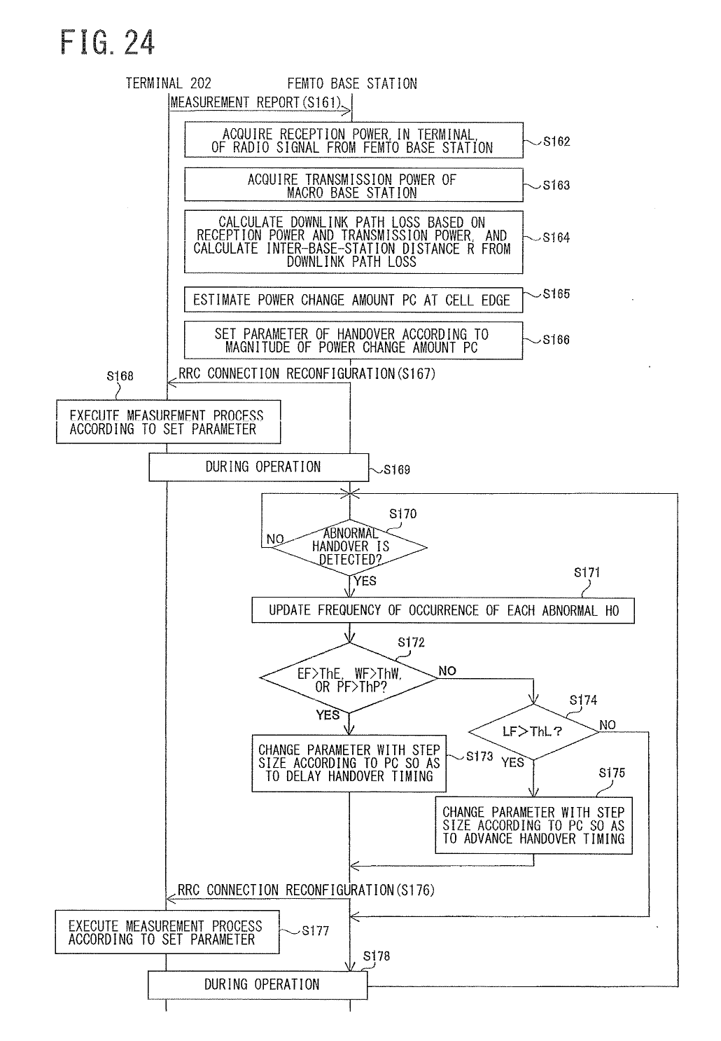

FIG. 24 is a sequence diagram that defines an operation procedure when the wireless base station device according to the embodiment of the present invention performs the handover operation optimizing process.

With reference to FIG. 24, first, the wireless terminal device 202 measures the reception powers of radio signals transmitted from the respective wireless base station devices, and transmits, to the femto base station, a measurement result notification indicating the measurement results of the reception powers (step S161).

Upon receiving the measurement result notification from the wireless terminal device 202, the femto base station acquires the reception power, in the wireless terminal device 202, of the radio signal transmitted from the femto base station (step S162).

Then, the femto base station acquires the transmission power of the radio signal of the macro base station. For example, the femto base station acquires a transmission power value included in broadcast information received from the macro base station, or acquires a transmission power value set by a user in advance (step S163).

Next, the femto base station calculates a downlink path loss which is a difference between the transmission power of the radio signal of the macro base station and the reception power of this radio signal in the wireless terminal device 202. Then, the femto base station, based on the downlink path loss, calculates an inter-base-station distance R between the femto base station and the macro base station (step S164).

The femto base station calculates the inter-base-station distance R by using the following equation:

path loss=128.1+37.6 log₁₀(R)

Next, the femto base station estimates the power change amount PC at a cell edge between a macro cell and a femto cell formed by the femto base station. For example, the femto base station determines that the power change amount PC is small when the inter-base-station distance R is larger than a predetermined threshold, and determines that the power change amount PC is large when the inter-base-station distance R is smaller than the predetermined threshold (step S165).

Next, the femto base station sets the parameter for the handover operation in accordance with the magnitude of the power change amount PC. For example, when the power change amount PC is small, the femto base station sets the parameter so as to delay the timing of the handover operation. Specifically, the hysteresis HS is set to be large, the TTT is set to be large, the offset OST is set to be small, the gap MG is set to be large, or the filtering coefficient α is set to be large. On the other hand, when the power change amount PC is large, the femto base station sets the parameter so as to advance the timing of the handover operation. Specifically, the hysteresis HS is set to be small, the TTT is set to be small, the offset OST is set to be large, the gap MG is set to be small, or the filtering coefficient α is set to be small (step S166).

Next, the femto base station includes the newly set parameter in an RRC connection reconfiguration instruction (RRC Connection Reconfiguration), and transmits the instruction to the wireless terminal device 202. The wireless terminal device 202 to which the RRC connection reconfiguration instruction is transmitted is not limited to the wireless terminal device 202 from which the above-mentioned measurement result notification has been transmitted, but may be any of wireless terminal devices 202 existing in the range of the cell formed by the femto base station (step S167).

Next, based on the newly set parameter indicated by the RRC connection reconfiguration instruction received from the femto base station, the wireless terminal device 202 performs measurement of the reception powers of the radio signals transmitted from the respective wireless base station devices, and transmission of a measurement result notification (step S168). Further, in the wireless communication system, the normal operation is performed (step S169).

When the femto base station detects an abnormal handover such as “Too Late HO”, “Too Early HO”, “HO to Wrong Cell”, or “Ping Pong HO” (YES in step S170), the femto base station updates the frequency of occurrence of the detected abnormal handover (step S171).

When the frequency of occurrence EF of “Too Early HO”, or the frequency of occurrence WF of “HO to Wrong Cell”, or the frequency of occurrence PF of “Ping Pong HO” is larger than a predetermined threshold ThE, or ThW, or ThP, respectively (YES in step S172), the femto base station sets the parameter so as to delay the timing of the handover operation, and sets the control width, i.e., the step size, of the parameter, in accordance with the magnitude of the estimated power change amount PC. For example, the femto base station sets the step size to be small when the power change amount PC is small, and sets the step size to be large when the power change amount PC is large.

On the other hand, when the frequency of occurrence EF, or the frequency of occurrence WF, or the frequency of occurrence PF is smaller than the predetermined threshold ThE, or ThW, or ThP, respectively (NO in step S172) and the frequency of occurrence LF of “Too Late HO” is larger than a predetermined threshold ThL (YES in step S174), the femto base station sets the parameter so as to advance the timing of the handover operation, and sets the control width, i.e., the step size, of the parameter, in accordance with the magnitude of the estimated power change amount PC. For example, the femto base station sets the step size to be small when the power change amount PC is small, and sets the step size to be large when the power change amount PC is large.

Next, the femto base station includes the newly set parameter in an RRC connection reconfiguration instruction (RRC Connection Reconfiguration), and transmits the instruction to the wireless terminal device 202. The wireless terminal device 202 to which the RRC connection reconfiguration instruction is transmitted is not limited to the wireless terminal device 202 from which the above-mentioned measurement result notification has been transmitted, but may be any of wireless terminal devices 202 existing in the range of the cell formed by the femto base station (step S176).

Next, based on the newly set parameter indicated by the RRC connection reconfiguration instruction received from the femto base station, the wireless terminal device 202 performs measurement of the reception powers of the radio signals transmitted from the respective wireless base station devices, and transmission of a measurement result notification (step S177). Then, in the wireless communication system, normal operation is carried out (step S178).

Thereafter, every time an abnormal handover is detected, the determination for parameter change and the parameter setting process are repeated, thereby optimizing the handover operation.

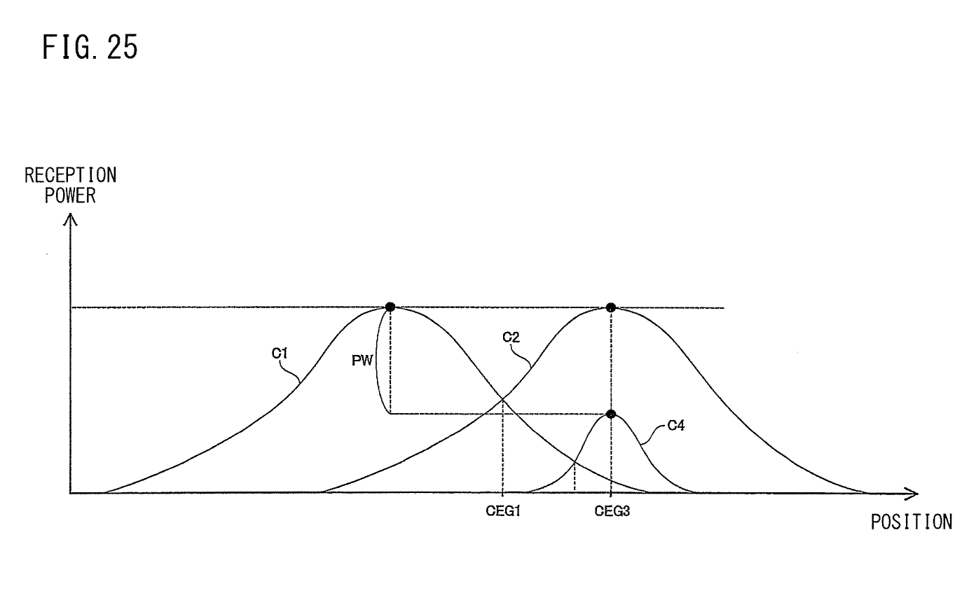

FIG. 25 is a diagram for explaining how the power change amount differs depending on a difference in transmission power between base stations. The way to see the figure is identical to that for FIG. 23.

With reference to FIG. 25, the distance between the cell C1 and the cell C2 is equal to the distance between the cell C1 and a cell C4. In this case, the power change amount PC is larger at a cell edge CEG3 between the cell C1 and the cell C4 having a transmission power difference of PW than at a cell edge CEG1 between the cell C1 and the cell C2 having a transmission power difference of zero.

The wireless base station device according to the embodiment of the present invention performs parameter adjustment by using the above relationship, for example.

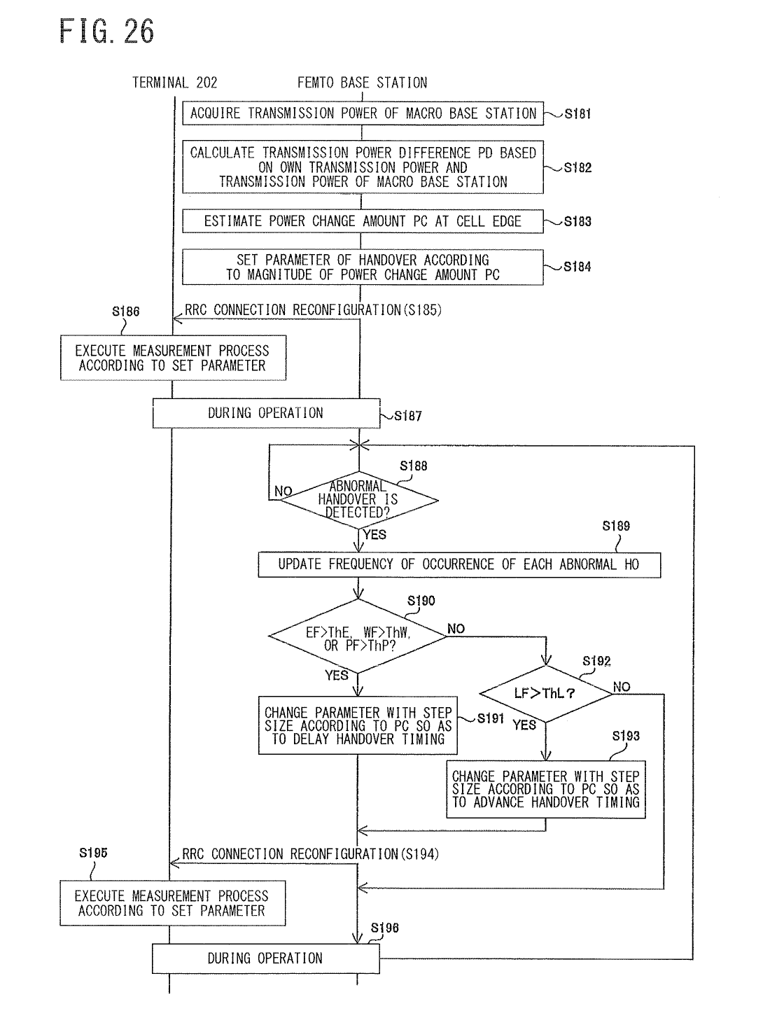

FIG. 26 is a sequence diagram that defines another example of an operation procedure when the wireless base station device according to the embodiment of the present invention performs a handover operation optimizing process.

With reference to FIG. 26, first, the femto base station acquires the transmission power of the radio signal of the macro base station. For example, the femto base station acquires a transmission power value included in the broadcast information received from the macro base station, or acquires a transmission power value set by a user in advance (step S181).

Next, the femto base station calculates a transmission power difference PD which is a difference between the transmission power of the femto base station and the transmission power of the macro base station (step S182).

Next, the femto base station estimates the power change amount PC at the cell edge between the macro cell and the femto cell formed by the femto base station. For example, the femto base station determines that the power change amount PC is small when the transmission power difference PD is smaller than a predetermined threshold, and determines that the power change amount PC is large when the transmission power difference PD is larger than the predetermined threshold (step S183).

Since the subsequent operation (steps S184 to S196) is identical to the operation (steps S166 to S178) in the sequence diagram shown in FIG. 24, repeated description is not necessary.

The femto base station may calculate the power change amount PC by using both the inter-base-station distance R and the transmission power difference PD. For example, a method using an evaluation function J (|R|, |PD|)=|PD|+C/|R| indicating the power change amount PC is considered. It is noted that C is a constant.

That is, when the inter-base-station distance R is increased, the value of the evaluation function J, i.e., the power change amount PC, is reduced. When the transmission power difference PD is increased, the value of the evaluation function J, i.e., the power change amount PC, is increased.

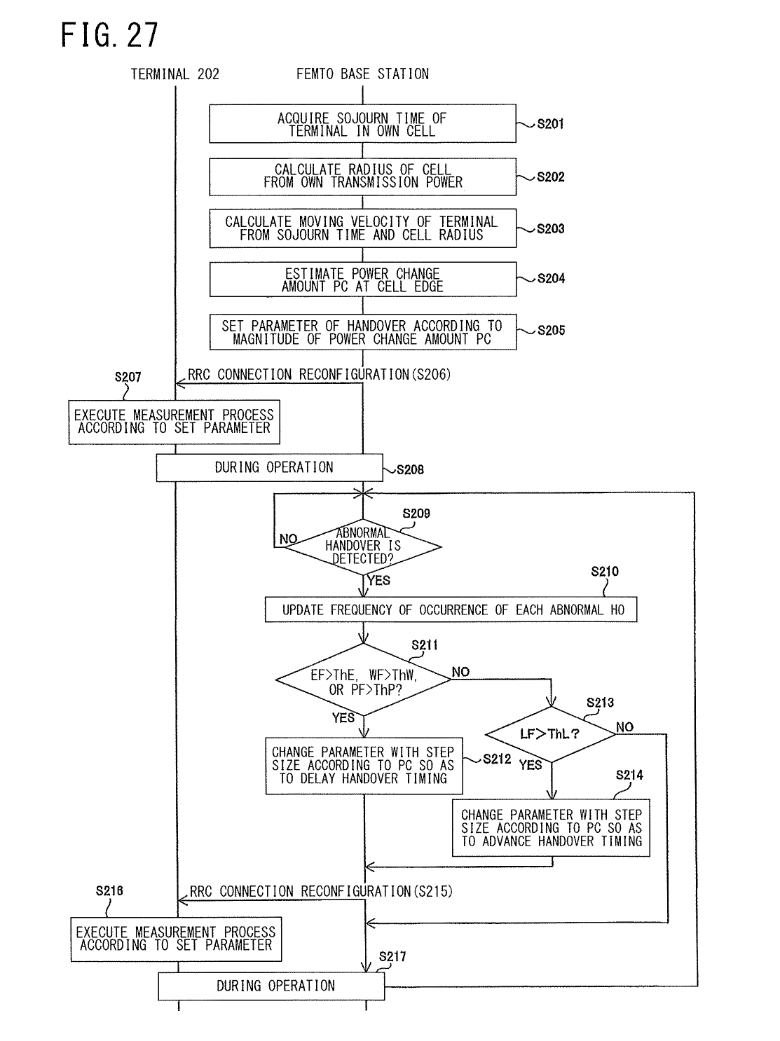

FIG. 27 is a sequence diagram that defines another example of an operation procedure when the wireless base station device according to the embodiment of the present invention performs a handover operation optimizing process.

With reference to FIG. 27, first, the femto base station acquires the cell dwell time of the wireless terminal device 202 in the cell formed by the femto base station (step S201).

Next, the femto base station calculates the radius of the cell formed by the femto base station, based on the transmission power of its own radio signal (step S202).

Next, the femto base station calculates the moving velocity of the wireless terminal device 202, based on the cell dwell time of the wireless terminal device 202 and the radius of its own cell. Specifically, the femto base station calculates (cell radius/cell dwell time) to obtain the moving velocity (step S203).

Next, the femto base station estimates the power change amount PC at the cell edge between the macro cell and the femto cell formed by the femto base station. For example, the femto base station determines that the power change amount PC is small when the calculated moving velocity is smaller than a predetermined threshold, and determines that the power change amount PC is large when the calculated moving velocity is larger than the predetermined threshold (step S204).

Since the subsequent operation (steps S205 to S217) is identical to the operation (steps S166 to S178) in the sequence diagram shown in FIG. 24, repeated description is not necessary.

As for the moving velocity, the moving velocities of a plurality of wireless terminal devices 202 existing in the cell of the femto base station may be used. For example, the maximum moving velocity among the moving velocities of the wireless terminal devices 202 may be used, or an average of the moving velocities of the wireless terminal devices 202 may be used.

Further, the moving velocity of the wireless terminal device 202 may be obtained from the positional information of the wireless terminal device 202. For example, a GPS (Global Positioning System) can be used.

Alternatively, LPP (LTE Positioning Protocol) defined in 3GPP may be used. That is, in downlink LPP, first, signals for LPP only are transmitted from three or more wireless base station devices. Next, the wireless terminal device 202 calculates differences in reception timings of the signals from the wireless base station devices, and notifies the serving base station of the calculation result. Based on the notified differences in reception timings, the serving base station estimates the position of the wireless terminal device 202.

Further, in uplink LPP, first, the wireless terminal device 202 transmits a signal for LPP only. Next, each of the wireless base station devices calculates the reception timing of the signal. Next, a host device of the wireless base station devices acquires the reception timings calculated in the wireless base station devices, and estimates the position of the wireless terminal device 202 based on the differences in the reception timings.

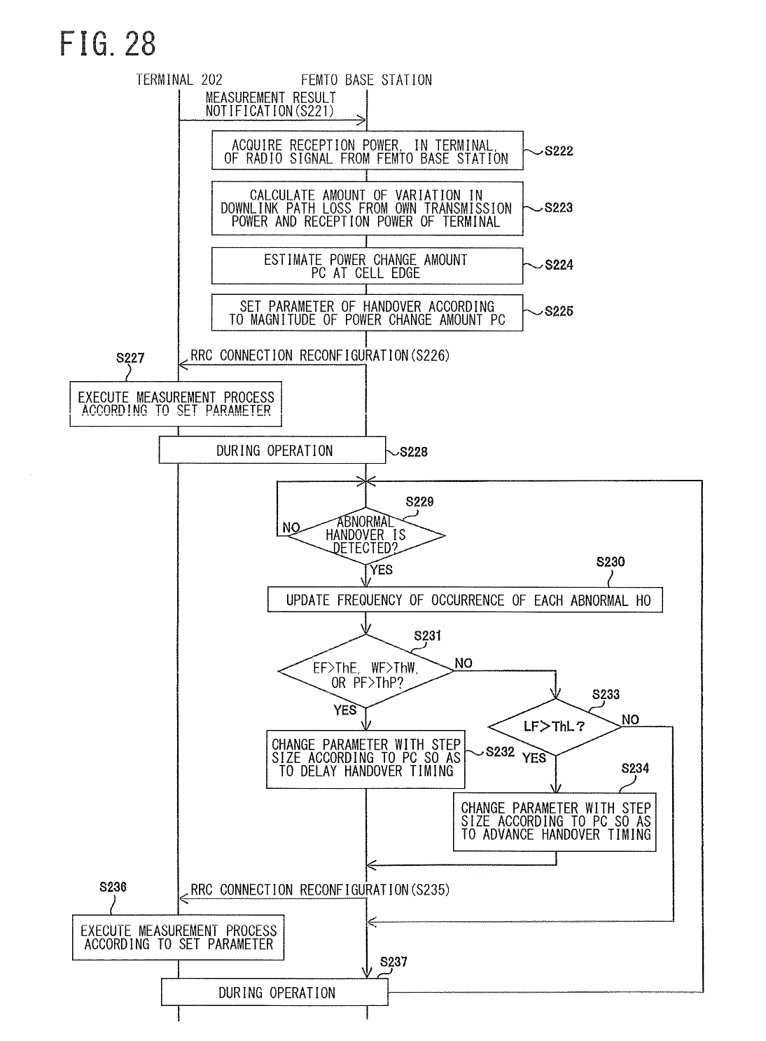

FIG. 28 is a sequence diagram that defines another example of an operation procedure when the wireless base station device according to the embodiment of the present invention performs a handover operation optimizing process.

With reference to FIG. 28, first, the wireless terminal device 202 measures the reception powers of the radio signals transmitted from the respective wireless base station devices, and transmits a measurement result notification indicating the measurement results of the reception powers, to the femto base station (step S221).

Upon receiving the measurement result notification from the wireless terminal device 202, the femto base station acquires the reception power, in the wireless terminal device 202, of the radio signal transmitted from the femto base station (step S222).

Next, the femto base station calculates a downlink path loss which is a difference between its own transmission power and the acquired reception power in the wireless terminal device 202. Further, the femto base station acquires a plurality of the reception powers at different timings, and calculates a temporal variation amount of the downlink path loss (step S223).

The variation amount is expressed as the following expected value E by using a path loss PL(t−1) based on the reception power measured at time (t−1) by the wireless terminal device 202, and a path loss PL(t) based on the reception power measured at time t later than time (t−1).

E[|PL(t)−PL(t−1)|²]

Next, the femto base station estimates the power change amount PC at the cell edge between the macro cell and the femto cell formed by the femto base station. For example, the femto base station determines that the power change amount PC is small when the calculated path loss variation amount is smaller than a predetermined threshold, and determines that the power change amount PC is large when the calculated path loss variation amount is larger than the predetermined threshold (step S224).

Since the subsequent operation (steps S225 to S237) is identical to the operation (steps S166 to S178) in the sequence diagram shown in FIG. 24, repeated description is not necessary.

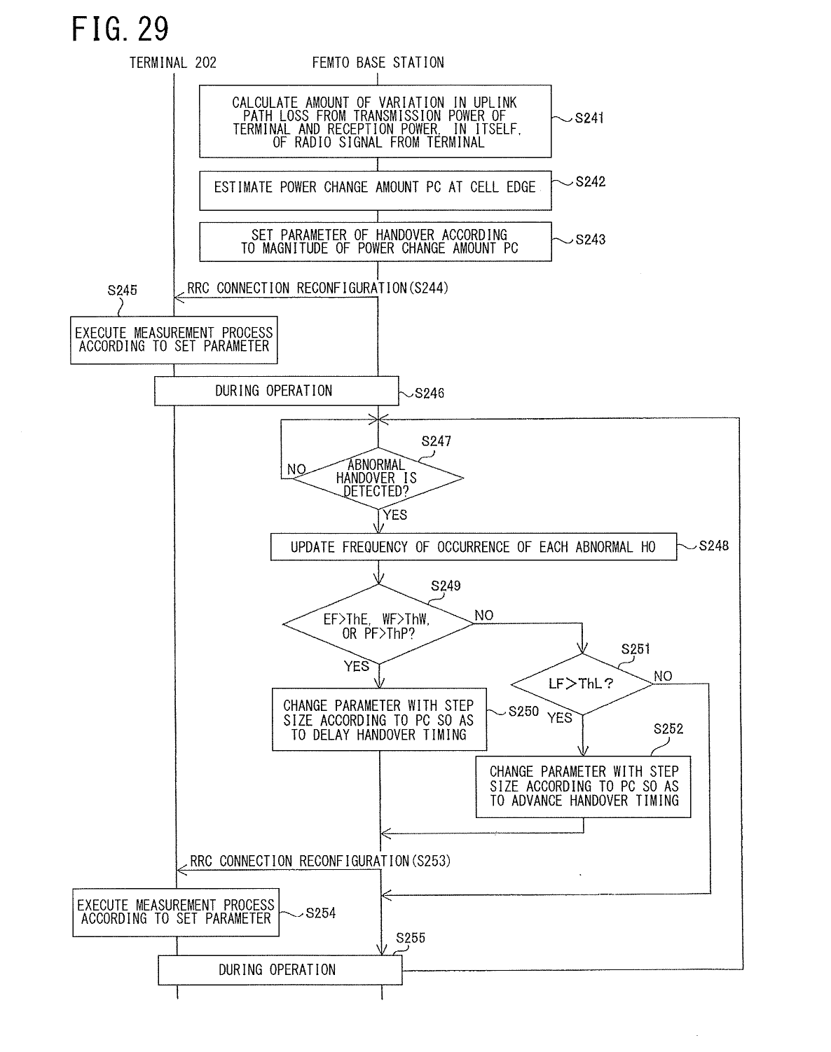

FIG. 29 is a sequence diagram that defines another example of an operation procedure when the wireless base station device according to the embodiment of the present invention performs a handover operation optimizing process.

With reference to FIG. 29, first, the femto base station acquires the transmission power of a radio signal of a wireless terminal device 202 existing in the range of the cell formed by the femto base station, and the reception power, in the femto base station, of the radio signal from the wireless terminal device 202. Then, the femto base station calculates an uplink path loss which is a difference between the transmission power and the reception power. Further, the femto base station acquires a plurality of the reception powers at different timings, and calculates a temporal variation amount of the uplink path loss (step S241).

The variation amount is expressed as the following expected value E by using a path loss PL(t−1) based on the reception power measured at time (t−1) by the femto base station, and a path loss PL(t) based on the reception power measured at time t later than time (t−1).

E[|PL(t)−PL(t−1)|²]

Next, the femto base station estimates the power change amount PC at the cell edge between the macro cell and the femto cell formed by the femto base station. For example, the femto base station determines that the power change amount PC is small when the calculated path loss variation amount is smaller than a predetermined threshold, and determines that the power change amount PC is large when the calculated path loss variation value is larger than the predetermined threshold (step S242).

Since the subsequent operation (steps S243 to S255) is identical to the operation (steps S166 to S178) in the sequence diagram shown in FIG. 24, repeated description is not necessary.

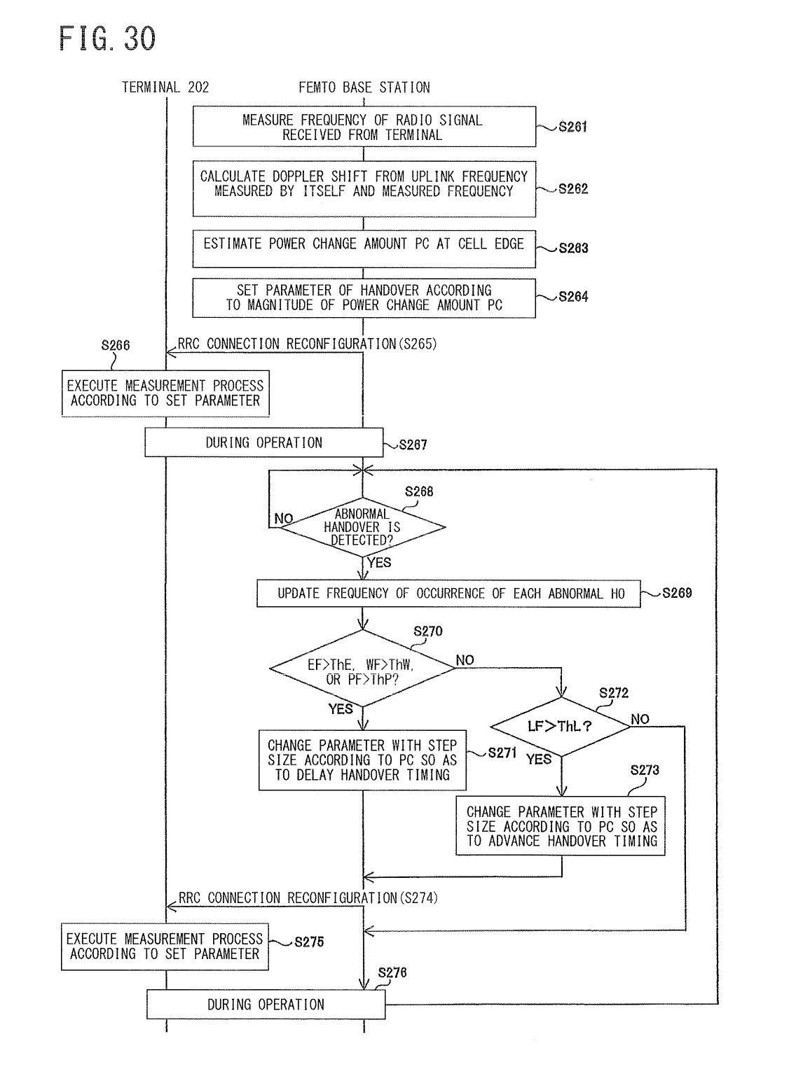

FIG. 30 is a sequence diagram that defines another example of an operation procedure when the wireless base station device according to the embodiment of the present invention performs a handover operation optimizing process.

With reference to FIG. 30, first, the femto base station acquires the frequency of a radio signal transmitted from a wireless terminal device 202 existing in the range of the cell formed by the femto base station (step S261).

Next, the femto base station calculates a Doppler shift which is a difference between a measured frequency and the frequency of the uplink set by the femto base station, i.e., the frequency of the radio signal transmitted from the wireless terminal device 202 (step S262).

When the wireless terminal device 202 is stationary, the Doppler shift is zero. The Doppler shift increases with an increase in the moving velocity of the wireless terminal device 202.

Next, the femto base station estimates the power change amount PC at the cell edge between the macro cell and the femto cell formed by the femto base station. For example, the femto base station determines that the power change amount PC is small when the calculated Doppler shift is smaller than a predetermined threshold, and determines that the power change amount PC is large when the calculated Doppler shift is larger than the predetermined threshold (step S263).

Since the subsequent operation (steps S264 to S276) is identical to the operation (steps S166 to S178) in the sequence diagram shown in FIG. 24, repeated description is not necessary.

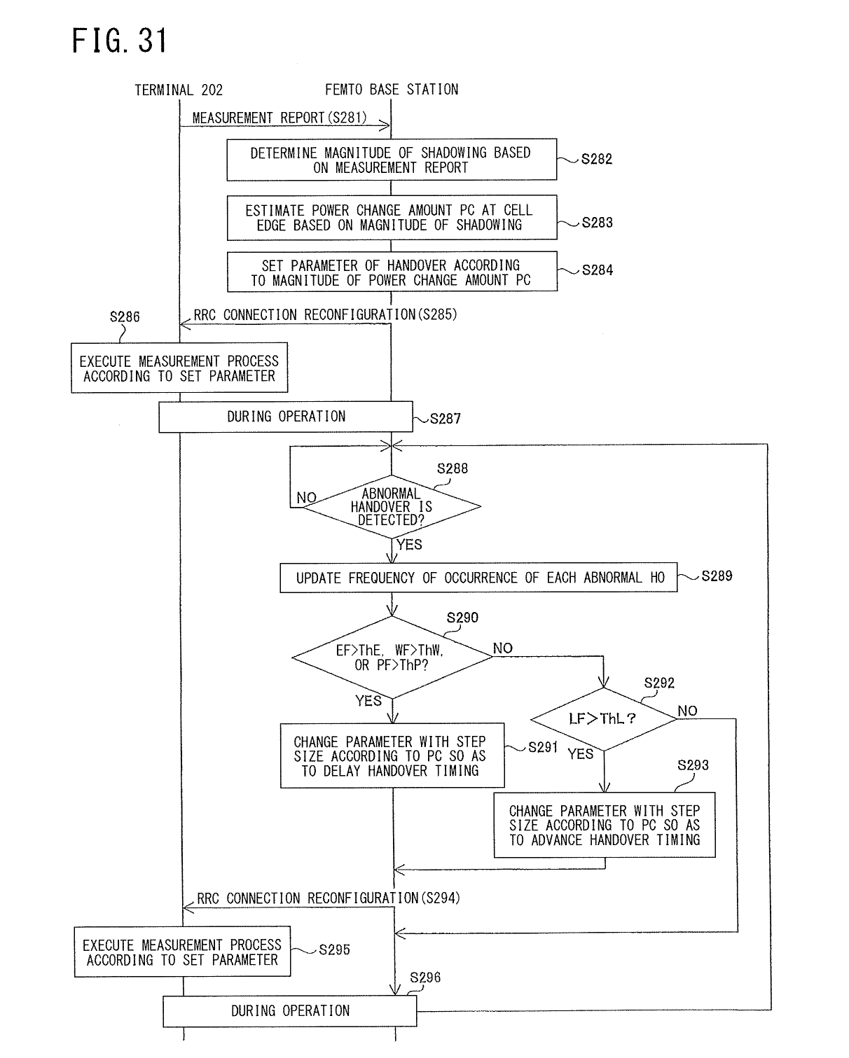

FIG. 31 is a sequence diagram that defines another example of an operation procedure when the wireless base station device according to the embodiment of the present invention performs a handover operation optimizing process.

With reference to FIG. 31, first, the wireless terminal device 202 measures the reception powers of the radio signals transmitted from the respective wireless base station devices, and transmits a measurement result notification indicating the measurement results of the reception powers, to the femto base station (step S281).

Upon receiving the measurement result notification from the wireless terminal device 202, the femto base station acquires the reception power, in the wireless terminal device 202, of the radio signal transmitted from the femto base station or another wireless base station device. Further, the femto base station acquires a plurality of the reception powers at different timings, and calculates a temporal variation amount of the reception power of the radio signal in the wireless terminal device 202. Based on the variation amount, the femto base station determines the magnitude of shadowing (step S282).

The variation amount is expressed as the following expected value E by using a reception power M(t−1) measured at time (t−1) by the wireless terminal device 202, and a reception power M(t) measured at time t later than time (t−1).

E[|M(t)−M(t−1)|²]

The femto base station may use the measurement result notifications from a plurality of wireless terminal devices 202. For example, the femto base station may use: a large variation amount among the variation amounts of the plurality of wireless terminal devices 202; a variation amount obtained by statistical processing such as averaging the variation amounts of the plurality of wireless terminal devices 202; the variation amount(s) of one or a plurality of wireless terminal devices 202 extracted at random; or the variation amount of a wireless terminal device 202 having a high moving velocity with reference to the parameters of the moving velocities of the wireless terminal devices 202, which are included in the measurement result notifications. Alternatively, some of these calculation methods may be combined.

Next, the femto base station estimates the power change amount PC at the cell edge between the macro cell and the femto cell formed by the femto base station. For example, the femto base station determines that the power change amount PC is small when the calculated shadowing is small, and determines that the power change amount PC is large when the calculated shadowing is large (step S283).

Since the subsequent operation (steps S284 to S296) is identical to the operation (steps S166 to S178) in the sequence diagram shown in FIG. 24, repeated description is not necessary.

By the way, the inappropriate handover operations described in Non-Patent Literature 1 cause various problems in the communication system, such as disconnection of communication, increase in communication traffic, and the like.

In contrast, in the wireless base station device according to the embodiment of the present invention, the terminal power information acquisition section 11 acquires the terminal power information indicating the degree of change in the reception power of the radio signal in the wireless terminal device 202 existing in the cell formed by the wireless base station device, with respect to the positional change of the wireless terminal device 202. Then, based on the terminal power information acquired by the terminal power information acquisition section 11, the handover control section 12 controls the timing of the handover operation of the wireless terminal device 202 from the wireless base station device to another wireless base station device.

According to the above configuration, the timing of the handover operation can be appropriately controlled by using the change of the reception state in association with the positional change of the wireless terminal device 202, thereby suppressing an inappropriate moving operation, and establishing a favorable communication system.

Therefore, in the wireless base station device according to the embodiment of the present invention, stabilized communication can be achieved by appropriately controlling the handover operation of the wireless terminal device.

Further, in the wireless base station device according to the embodiment of the present invention, the handover control section 12 controls the timing of the handover operation to be advanced when the degree of change indicated by the terminal power information is large, and controls the timing of the handover operation to be delayed when the degree of change is small.

According to the above configuration, the handover operation can be optimized by appropriately setting the parameter for controlling the timing of the moving operation.

The parameter adjustment for “Too Early HO”, “HO to Wrong Cell”, and “Ping Pong HO” and the parameter adjustment for “Too Late HO” are in the trade-off relationship. That is, the parameter change to make “Too Early HO”, “HO to Wrong Cell”, and “Ping Pong HO” unlikely to occur may become the parameter change to make “Too Late HO” likely to occur, and the parameter change to make “Too Late HO” unlikely to occur may become the parameter change to make “Too Early HO”, “HO to Wrong Cell”, and “Ping Pong HO” likely to occur. That is, the parameter adjustment may not be converged depending on the radio environment.

So, in the wireless base station device according to the embodiment of the present invention, the handover control section 12 sets the control width for the timing of the handover operation to be large when the degree of change indicated by the terminal power information is large, and sets the control width for the timing of the handover operation to be small when the degree of change is small.

Thus, the convergence speed and stability of the process of optimizing the handover operation can be enhanced by adaptively changing the step size of the parameter adjustment.

Further, in the wireless base station device according to the embodiment of the present invention, the terminal power information acquisition section 11 acquires the terminal power information indicating the degree of change in the state where the index indicating the reception quality of the radio signal transmitted from the wireless base station device is equal to or smaller than a predetermined value in the wireless terminal device 202, or in the state where the reception power of the radio signal transmitted from the another wireless base station device is equal to or larger than the predetermined value in the wireless terminal device 202.

According to the above configuration, the timing of the handover operation can be controlled more appropriately by using the power change amount PC at an appropriate position in the wireless communication system.

Further, in the wireless base station device according to the embodiment of the present invention, the terminal power estimation section 13 estimates the degree of change, based on the distance between the wireless base station device and the another wireless base station device.

According to the above configuration, the reception environment of the wireless terminal device 202 can be appropriately evaluated in accordance with the magnitude of the inter-base-station distance, thereby estimating the power change amount PC more accurately.

Further, in the wireless base station device according to the embodiment of the present invention, the inter-base-station distance estimation section 16 estimates the distance between the wireless base station device and the another wireless base station device, based on a difference between the transmission power of the radio signal transmitted from the another wireless base station device, and the reception power, in the cell formed by the wireless base station device, of the radio signal transmitted from the another wireless base station device. Then, the terminal power estimation section 13 estimates the degree of change based on the distance estimated by the inter-base-station distance estimation section 16.

According to the above configuration using the downlink path loss which is a difference between the transmission power of the radio signal of the another wireless base station device and the reception power of the radio signal in the own cell, the inter-base-station distance R can be estimated more accurately. Further, a user need not previously set the inter-base-station distance R in the wireless base station device.

Further, in the wireless base station device according to the embodiment of the present invention, the terminal power estimation section 13 estimates the degree of change, based on a difference between the transmission power of the radio signal transmitted from the wireless base station device and the transmission power of the radio signal transmitted from the another wireless base station device.

According to the above configuration, the reception environment of the wireless terminal device 202 can be appropriately evaluated in accordance with the magnitude of the difference in transmission power between the base stations, thereby estimating the power change amount PC more accurately.

Further, in the wireless base station device according to the embodiment of the present invention, the terminal power estimation section 13 estimates the degree of change, based on the moving velocity of the wireless terminal device 202 existing in the range of the cell formed by the wireless base station device.

According to the above configuration, the reception environment of the wireless terminal device 202 can be appropriately evaluated in accordance with the magnitude of the moving velocity of the wireless terminal device 202, thereby estimating the power change amount PC more accurately.

Further, in the wireless base station device according to the embodiment of the present invention, the terminal power estimation section 13 estimates the degree of change, based on a temporal change in a difference between the transmission power of the radio signal transmitted from the another wireless base station device, and the reception power, in the cell formed by the wireless base station device, of the radio signal transmitted from the another wireless base station device.

According to the above configuration, the reception environment of the wireless terminal device 202 can be appropriately evaluated in accordance with the magnitude of the temporal change in the downlink path loss which is the difference between the transmission power of the radio signal of the another wireless base station device and the reception power of the radio signal in the own cell, thereby estimating the power change amount PC more accurately.

Further, in the wireless base station device according to the embodiment of the present invention, the terminal power estimation section 13 estimates the degree of change, based on a temporal change in a difference between the transmission power of the radio signal transmitted from the wireless terminal device 202 existing in the range of the cell formed by the wireless base station device, and the reception power of the radio signal in the wireless base station device.

According to the above configuration, the reception environment of the wireless terminal device 202 can be appropriately evaluated in accordance with the magnitude of the temporal change in the uplink path loss which is a difference between the transmission power of the radio signal of the wireless terminal device 202 and the reception power of the radio signal in the wireless base station device, thereby estimating the power change amount PC more accurately.

Further, in the wireless base station device according to the embodiment of the present invention, the terminal power estimation section 13 estimates the degree of change, based on a difference between the frequency of the radio signal transmitted from the wireless terminal device 202 existing in the range of the cell formed by the wireless base station device, and the frequency of the radio signal received by the wireless base station device.

According to the above configuration, the reception environment of the wireless terminal device 202 can be appropriately evaluated in accordance with the magnitude of the Doppler shift which is a difference between the frequency of the radio signal of the wireless terminal device 202 and the frequency of the radio signal received by the wireless base station device, thereby estimating the power change amount PC more accurately.

Further, in the wireless base station device according to the embodiment of the present invention, the terminal power estimation section 13 estimates the degree of change based on a temporal change in the reception power of the radio signal in the wireless terminal device 202.

According to the above configuration, the reception environment of the wireless terminal device 202 can be appropriately evaluated in accordance with the magnitude of shadowing in the wireless terminal device 202, thereby estimating the power change amount PC more accurately.

Further, in the wireless base station device according to the embodiment of the present invention, the terminal power estimation section 13 acquires the temporal change in the reception power, based on the measurement result of the reception power of the radio signal in the wireless terminal device 202 existing in the range of the cell formed by the wireless base station device.

According to the above configuration using the measurement result of the wireless terminal device 202, the shadowing in the wireless terminal device 202 can be estimated more accurately.

Further, in the wireless base station device according to the embodiment of the present invention, the terminal power estimation section 13 estimates the degree of change, based on a temporal change in the reception power of a wireless terminal device 202 having a relatively high moving velocity among a plurality of wireless terminal devices 202 existing in the range of the cell formed by the wireless base station device.

According to the above configuration in which the wireless terminal device 202 whose shadowing is more likely to increase is selected and the reception environment of the selected wireless terminal device is estimated, the power change amount PC can be estimated more accurately.

In the embodiment of the present invention, the handover operation of a wireless terminal device has been specifically described. However, the present invention is applicable not only to “handover” that is an inter-base-station movement (inter-cell movement) operation performed by a wireless terminal device communicating with a wireless base station device but also to an inter-base-station movement (inter-cell movement) operation performed by a wireless terminal device in the idle state. That is, the present invention is also applicable to configurations and operations in which “handover” of the embodiment of the present invention is replaced with “movement”.

Further, in the wireless base station device according to the embodiment of the present invention, the control unit 98 is configured to estimate the power change amount PC of the wireless terminal device 202. However, the configuration of the control unit 98 is not limited thereto. The control unit 98 may be configured to not only estimate the power change amount PC but also acquire a result of estimation or the like of another device.

Further, the wireless base station device according to the embodiment of the present invention is configured to calculate by itself the inter-base-station distance R, the transmission power difference PD, the moving velocity of a wireless terminal device 202, the path loss, the Doppler shift, and the shadowing. However, the wireless base station device is not limited thereto, and may be configured to acquire a result of calculation of another device.

Further, in the wireless base station device according to the embodiment of the present invention, the control unit 98 is configured to control the timing of the handover operation, based on the power change amount PC. However, the wireless base station device is not limited thereto, and may be configured as follows. That is, the control unit 98 does not use the power change amount PC, and acquires at least one piece of information among: a distance between the wireless base station device and another wireless base station device; a difference in transmission power between a radio signal transmitted from the wireless base station device and a radio signal transmitted from the another wireless base station device; the moving velocity of a wireless terminal device 202 existing in the range of a cell formed by the wireless base station device; a temporal change in a difference between the transmission power of the radio signal transmitted from the another wireless base station device, and the reception power, in the cell formed by the wireless base station device, of the radio signal transmitted from the another wireless base station device; a temporal change in a difference between the transmission power of a radio signal transmitted from a wireless terminal device 202 existing in the range of the cell formed by the wireless base station device, and the reception power of the radio signal in the wireless base station device; a difference between the frequency of a radio signal transmitted from the wireless terminal device 202 existing in the range of the cell formed by the wireless base station device, and the frequency of the radio signal received by the wireless base station device; and a temporal change in the reception power of a radio signal in a wireless terminal device 202. Then, the control unit 98 controls the timing of the handover operation based on the acquired information.

Also when above configuration is adopted, the reception environment of the wireless terminal device 202 can be appropriately evaluated, and thereby the timing of the handover operation can be appropriately controlled. Therefore, it is possible to suppress an inappropriate handover operation, and configure a favorable communication system. Accordingly, stabilized communication can be achieved by appropriately controlling the handover operation of the wireless terminal device.

Some or all of the components and operations of the units according to the embodiment of the present invention may be arbitrarily combined.

Note that the embodiments disclosed are to be considered in all respects as illustrative and not restrictive. The scope of the invention is indicated by the appended claims rather than by the foregoing meaning, and all changes which come within the meaning and range of equivalency of the claims are therefore intended to be embraced therein.

### REFERENCE SIGNS LIST

11 terminal power information acquisition section
12 handover control section (moving operation control section)
13 terminal power estimation section
14 base station measurement section
15 terminal measurement result acquisition section
16 inter-base-station distance estimation section
91 antenna
92 circulator
93 radio reception unit
94 radio transmission unit
95 signal processing unit
96 reception signal processing section
97 transmission signal processing section
98 control unit
101A, 101B, 101C wireless base station device

1. A wireless base station device that transmits and receives a radio signal to and from a wireless terminal device in a communication system in which the wireless terminal device is communicable with a plurality of wireless base station devices by performing a moving operation, the wireless base station device comprising:
a terminal power information acquisition section that acquires terminal power information indicating a degree of change in a reception power of the radio signal in a wireless terminal device existing in the range of a cell formed by the wireless base station device, with respect to a positional change of the wireless terminal device; and
a moving operation control section that controls, based on the terminal power information acquired by the terminal power information acquisition section, timing of the moving operation of the wireless terminal device from the wireless base station device to another wireless base station device.

2. The wireless base station device according to claim 1, wherein
the moving operation control section controls the timing of the moving operation to be advanced when the degree of change indicated by the terminal power information is large, and controls the timing of the moving operation to be delayed when the degree of change is small.

3. The wireless base station device according to claim 1, wherein
the moving operation control section sets a control width for the timing of the moving operation to be large when the degree of change indicated by the terminal power information is large, and sets the control width for the timing of the moving operation to be small when the degree of change is small.

4. The wireless base station device according to claim 1, wherein
the terminal power information acquisition section acquires the terminal power information indicating the degree of change in a state where an index indicating a reception quality of the radio signal transmitted from the wireless base station device is equal to or smaller than a predetermined value in the wireless terminal device, or in a state where a reception power of a radio signal transmitted from the another wireless base station device is equal to or larger than a predetermined value in the wireless base station device.

5. The wireless base station device according to claim 1, further comprising:
a terminal power estimation section that estimates the degree of change, based on a distance between the wireless base station device and the another wireless base station device, wherein
the terminal power information acquisition section acquires, as the terminal power information, the degree of change estimated by the terminal power estimation section.

6. The wireless base station device according to claim 5, further comprising:
an inter-base-station distance estimation section that estimates the distance between the wireless base station device and the another wireless base station device, based on a difference between a transmission power of the radio signal transmitted from the another wireless base station device and a reception power, in the cell formed by the wireless base station device, of the radio signal transmitted from the another wireless base station device, wherein
the terminal power estimation section estimates the degree of change based on the distance estimated by the inter-base-station distance estimation section.

7. The wireless base station device according to claim 1, further comprising:
a terminal power estimation section that estimates the degree of change, based on a difference between a transmission power of the radio signal transmitted from the wireless base station device and a transmission power of a radio signal transmitted from the another wireless base station device, wherein
the terminal power information acquisition section acquires, as the terminal power information, the degree of change estimated by the terminal power estimation section.

8. The wireless base station device according to claim 1, further comprising:
a terminal power estimation section that estimates the degree of change, based on a moving velocity of the wireless terminal device existing in the range of the cell formed by the wireless base station device, wherein
the terminal power information acquisition section acquires, as the terminal power information, the degree of change estimated by the terminal power estimation section.

9. The wireless base station device according to claim 1, further comprising:
a terminal power estimation section that estimates the degree of change, based on a temporal change in a difference between a transmission power of a radio signal transmitted from the another wireless base station device and a reception power, in the cell formed by the wireless base station device, of the radio signal transmitted from the another wireless base station device, wherein
the terminal power information acquisition section acquires, as the terminal power information, the degree of change estimated by the terminal power estimation section.

10. The wireless base station device according to claim 1, further comprising:
a terminal power estimation section that estimates the degree of change, based on a temporal change in a difference between a transmission power of a radio signal transmitted from the wireless terminal device existing in the range of the cell formed by the wireless base station device, and a reception power of the radio signal in the wireless base station device, wherein
the terminal power information acquisition section acquires, as the terminal power information, the degree of change estimated by the terminal power estimation section.

11. The wireless base station device according to claim 1, further comprising:
a terminal power estimation section that estimates the degree of change, based on a difference between a frequency of a radio signal transmitted from the wireless terminal device existing in the range of the cell formed by the wireless base station device, and a frequency of the radio signal received by the wireless base station device, wherein
the terminal power information acquisition section acquires, as the terminal power information, the degree of change estimated by the terminal power estimation section.

12. The wireless base station device according to claim 1, further comprising:
a terminal power estimation section that estimates the degree of change, based on a temporal change in a reception power of a radio signal in a wireless terminal device, wherein
the terminal power information acquisition section acquires, as the terminal power information, the degree of change estimated by the terminal power estimation section.

13. The wireless base station device according to claim 12, wherein
the terminal power estimation section acquires the temporal change in the reception power, based on a measurement result of a reception power of a radio signal in a wireless terminal device existing in the range of the cell formed by the wireless base station device.

14. The wireless base station device according to claim 12, wherein
the terminal power estimation section estimates the degree of change, based on the temporal change in the reception power of the wireless terminal device having a high moving velocity among a plurality of wireless terminal devices existing in the range of the cell formed by the wireless base station device.

15. A wireless base station device that transmits and receives a radio signal to and from a wireless terminal device in a communication system in which the wireless terminal device is communicable with a plurality of wireless base station devices by performing a moving operation, the wireless base station device comprising:
an information acquisition section that acquires at least one piece of information among: a distance between the wireless base station device and another wireless base station device; a difference in transmission power between a radio signal transmitted from the wireless base station device and a radio signal transmitted from the another wireless base station device; a moving velocity of a wireless terminal device existing in the range of a cell formed by the wireless base station device; a temporal change in a difference between the transmission power of the radio signal transmitted from the another wireless base station device and a reception power, in the cell formed by the wireless base station device, of the radio signal transmitted from the another wireless base station device; a temporal change in a difference between a transmission power of a radio signal transmitted from the wireless terminal device existing in the range of the cell formed by the wireless base station device, and a reception power of the radio signal in the wireless base station device; a difference between a frequency of the radio signal transmitted from the wireless terminal device existing in the cell formed by the wireless base station device, and a frequency of the radio signal received by the wireless base station device; and a temporal change in a reception power of a radio signal in a wireless terminal device; and
a moving operation control section that controls timing of a moving operation of a wireless terminal device from the wireless base station device to the another wireless base station device, based on the information acquired by the information acquisition section.

16. A communication control method for a wireless base station device that transmits and receives a radio signal to and from a wireless terminal device in a communication system in which the wireless terminal device is communicable with a plurality of wireless base station devices by performing a moving operation, the communication control method comprising the steps of:
acquiring terminal power information indicating a degree of change in a reception power of the radio signal in a wireless terminal device existing in the range of a cell formed by the wireless base station device, with respect to a positional change of the wireless terminal device; and
controlling, based on the acquired terminal power information, timing of the moving operation of the wireless terminal device from the wireless base station device to another wireless base station device.

17. A communication control program for a wireless base station device that transmits and receives a radio signal to and from a wireless terminal device in a communication system in which the wireless terminal device is communicable with a plurality of wireless base station devices by performing a moving operation, the communication control program causing a computer to execute the steps of:
acquiring terminal power information indicating a degree of change in a reception power of the radio signal in a wireless terminal device existing in the range of a cell formed by the wireless base station device, with respect to a positional change of the wireless terminal device; and
controlling, based on the acquired terminal power information, timing of the moving operation of the wireless terminal device from the wireless base station device to another wireless base station device.
